(19) United States
(12) Patent Application Publication
(10) Pub. No.: US 2019/0025719 A1
(43) Pub. Date: Jan. 24, 2019

(54) ELECTROPHOTOGRAPHIC PHOTORECEPTOR FOR POSITIVE CHARGING, ELECTROPHOTOGRAPHIC PHOTORECEPTOR CARTRIDGE, AND IMAGE FORMING APPARATUS

(71) Applicant: Mitsubishi Chemical Corporation, Tokyo (JP)

(72) Inventor: Daisuke YAMAZAKI, Kanagawa (JP)

(73) Assignee: Mitsubishi Chemical Corporation, Tokyo (JP)

(21) Appl. No.: 16/143,979

(22) Filed: Sep. 27, 2018

Related U.S. Application Data
(63) Continuation of application No. PCT/JP2017/012767, filed on Mar. 28, 2017.

(30) Foreign Application Priority Data
Mar. 29, 2016 (JP) 2016-066782

(51) Int. Cl. G03G 5/05; G03G 15/00; G03G 5/06

(52) U.S. Cl. CPC G03G 5/0546; G03G 15/75; G03G 5/0696; G03G 5/0677; G03G 5/0609; G03G 5/0605; G03G 5/0614

(57) ABSTRACT

The present invention relates to an electrophotographic photoreceptor for positive charging, the photoreceptor comprising: a conductive support; and a single-layer type photosensitive layer disposed on the conductive support, the single-layer type photosensitive layer containing a binder resin, a compound (1) having hole transporting ability, and a compound (2) having electron-transporting ability, wherein the level Ah of a compound having a highest energy level of HOMO in the compound (1), the level BI of a compound having a lowest energy level of LUMO in the compound (2), and an energy level Ch of HOMO of another compound C which has a molecular weight of 500 or less and is contained in the photosensitive layer satisfy specific equations.

### TECHNICAL FIELD

The present invention relates to an electrophotographic photoreceptor for positive charging, an electrophotographic photoreceptor cartridge, and an image forming apparatus. In particular, the present invention relates to an electrophotographic photoreceptor for positive charging which is excellent in wear resistance and has an improved charging property at a very initial stage of life duration thereof, an electrophotographic photoreceptor cartridge, and an image forming apparatus.

### BACKGROUND ART

Electrophotography has been widely used in the field of copiers, printers, complex devices and digital printing, because of the ability to produce high-quality images in a high speed, and the like. Regarding electrophotographic photoreceptors (hereinafter, simply also referred to as “photoreceptor”), which are the core of electrophotography, photoreceptors employing an organic photoconductive substance having advantages such as non-pollution, ease of film formation, and ease of production has been mainly used.

Regarding an organic electrophotographic photoreceptor, since a so-called function allocation type photoreceptor, in which different compounds are separately in charge of charge generation and charge transport, has a wider range of selecting materials and can easily control photoreceptor properties, such function-allocation type photoreceptor becomes the mainstream. In terms of layer constitution, as known photoreceptors, there exist a single-layer type electrophotographic photoreceptor (hereinafter, simply also referred to as “single-layer type photoreceptor”) and a multilayer type electrophotographic photoreceptor (hereinafter, simply also referred to as “multilayer type photoreceptor”): the former is a photoreceptor that contains a charge generation material and a charge transport material within the same layer; and the latter is a photoreceptor in which separate layers (charge generation layer and charge transport layer) each including the charge generation material and the charge transport material respectively are laminated.

Among these photoreceptors, in terms of photoreceptor designing, the multilayer type photoreceptor is a photoreceptor in which the function of each layer can be easily optimized and the characteristics thereof are also easily controlled, and thus, most of the current photoreceptors are of this type. Almost every multilayer type photoreceptor includes a charge generation layer and a charge transport layer disposed on a substrate in this order. Regarding the charge transport layer, there are extremely few materials suitable for an electron transport material, whereas many materials having excellent characteristics for a hole transport material are known. Therefore, the charge generation layer and the charge transport layer are layered on the substrate in this order and the photoreceptor is used negatively charged.

On the contrary, the single-layer type photoreceptor is a photoreceptor that may use any of the negative charging system and the positive charging system in principle, and the positive charging system is advantageous since ozone generation which is the problem in the use of the multilayer type photoreceptor can be prevented, and it is easier to be generally more sensitive than the negative charging system. In addition, the single-layer type photoreceptor with a positive charging system also has advantages of a fewer coating processes and advantageous resolution. Despite some of the inferior characteristics in terms of electrical properties compared to those of the negative charging multilayer type photoreceptor, the single-layer type photoreceptor has been partly put into practical, and various studies regarding improvement thereof are ongoing until now (PTLs 1 to 5).

### CITATION LIST

### Patent Literature

[PTL 1]: JP-A-5-92936

[PTL 2]: JP-A-2-228670

[PTL 3]: JP-A-2001-33997

[PTL 4]: JP-A-2005-331965

[PTL 5]: JP-A-2013-231866

### SUMMARY OF THE INVENTION

### Technical Problem

However, regarding the single-layer type photoreceptor, when an image is output after the photoreceptor after production is mounted onto a printer, there occurs problems of an image defect in the initial printing process of about 10 sheets, such as so-called fog, in which a fine black spot is generated on a paper, or a black band in which the density of a part of the halftone image is enlarged. Since this phenomenon only occurs on an initial image of about 10 sheets of printing and does not occurs thereafter, it is estimated that it is because certain transitionally abnormal part is formed on a surface of the photoreceptor. When measuring electrical properties the photoreceptor, as shown in FIG. 1A, it is seen that the photoreceptor on which the fog occurs is in a poor charging state initially, and the poor charging state is not improved without about 10 sheets of printing. On the contrary, as shown in FIG. 1B, the poor initial charging state does not occur in a case of containing no electronic transport material.

Thus, it is estimated that, when analysis of the outermost surface and near-surface depth direction is performed by time-of-flight secondary ion mass spectrometry (abbreviated as TOF-SIMS), the electronic transport material bled out from the surface of the photosensitive layer is one reason of the poor initial charging state. Thus, a method is required for preventing an electronic transport material having a low molecular weight from bleeding out from the surface of the photoreceptor when producing the photoreceptor by coating.

Along with the speed-up and image quality enhancing of the copiers or printers in recent years, a photoreceptor with higher performance is required in terms of both electrical properties and mechanical properties in any charging type. Among these, in terms of mechanical properties, improvement of wear resistance, and improvement of the filming property and the cleaning property of the outermost surface of the photoreceptor are one of the problems to be solved, in order to cope with long term use. A photoreceptor containing a polyarylate resin on the outermost surface is known as a photoreceptor satisfying these requirements.

However, when the polyarylate resin is used in the above-described positive charging photoreceptor, the poor initial charging phenomenon deteriorates, and thus a photoreceptor is required for satisfying both the mechanical properties and the initial charging property.

An object of the present invention is to provide a good image output from the first sheet of printing without occurrence of poor initial charging even in a case of using a polyarylate resin in a single-layer type electrophotographic photoreceptor for positive charging.

### Solution to Problem

The inventors of the present invention have found that by using a polyarylate resin as a binder resin in a single-layer type photosensitive layer and containing a specific compound, the wear resistance, the filming resistance and the cleaning property can be improved and the poor charging of a photoreceptor at a very initial stage of life duration thereof can be improved.

Namely, the gist of the present invention resides in the following <1> to <7>.

<1> An electrophotographic photoreceptor for positive charging, the photoreceptor comprising:

a conductive support; and

a single-layer type photosensitive layer disposed on the conductive support, the single-layer type photosensitive layer at least containing a binder resin, a compound having hole transporting ability, and a compound having electron-transporting ability,

wherein the binder resin contains a polyarylate resin, and

when in density function calculation B3LYP/6-31G (d, p),
designating a compound having hole transporting ability with a highest energy level of HOMO in the compound having hole transporting ability as a compound A, and setting the energy level of HOMO of the compound A to Ah,
designating a compound having electron-transporting ability with a lowest energy level of LUMO in the compound having electron-transporting ability as a compound B, and setting the energy level of LUMO of the compound B to BI, and
designating a compound which has a molecular weight of 500 or less and is contained other than the compound A and the compound B in the single-layer type photosensitive layer as a compound C, and setting an energy level of HOMO of the compound C to Ch,

the following Equations (1a), (2a), and (3a) are satisfied:

Ch≤−4.69 (eV) (1a)

Ah−Ch≥0.10 (eV) (2a)

Bl−Ch≥1.18 (eV) (3a).

<2> The electrophotographic photoreceptor according to <1>, wherein

the Equation (2a) is

Ah−Ch≥0.11 (eV).

<3> The electrophotographic photoreceptor according to <1> or <2>, wherein

when an energy level of LUMO of the compound C is set to Cl, the Ch and the Cl satisfy the following Equations (4a) and (5a):

Ch≤−4.9 (eV) Equation (4a)

Cl≥−3.2 (eV) Equation (5a).

<4> The electrophotographic photoreceptor according to any one of <1> to <3>, which comprises the compound C in an amount of 13 mass % or more based on the compound having electron-transporting ability.
<5> The electrophotographic photoreceptor according to any one of <1> to <4>, wherein the polyarylate resin has a structural unit represented by the following General Formula (1b):

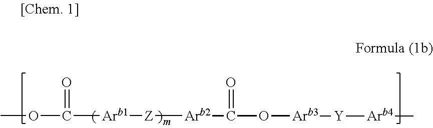

wherein Ar^{b1} to Ar^{b4} each independently represent an arylene group that may have a substituent, Z represents a single bond, an oxygen atom, a sulfur atom, or an alkylene group, m represents an integer of 0 to 2, and Y represents a single bond, an oxygen atom, a sulfur atom, or an alkylene group.
<6> An electrophotographic photoreceptor cartridge, comprising:
the electrophotographic photoreceptor for positive charging according to any one of <1> to <5>; and
at least one of a charging unit for charging the electrophotographic photoreceptor, an exposure unit for exposing the charged electrophotographic photoreceptor to light so as to form an electrostatic latent image thereon, a developing unit for developing the electrostatic latent image formed on the electrophotographic photoreceptor, and a cleaning unit for cleaning the electrophotographic photoreceptor.
   <7> An image forming apparatus, comprising:
the electrophotographic photoreceptor for positive charging according to any one of <1> to <5>;
a charging unit for charging the electrophotographic photoreceptor;
an exposure unit for exposing the charged electrophotographic photoreceptor to light so as to form an electrostatic latent image thereon; and
a developing unit for developing the electrostatic latent image formed on the electrophotographic photoreceptor.

### Advantageous Effects of Invention

The electrophotographic photoreceptor of the present invention is one in which the wear resistance, the filming resistance, the cleaning property and the poor charging property at a very initial stage of life duration of a photoreceptor are improved by using a specific binder resin and a specific compound in a photosensitive layer. An electrophotographic photoreceptor cartridge comprising the electrophotographic photoreceptor and an image forming apparatus comprising the electrophotographic photoreceptor can be provided.

### BRIEF DESCRIPTION OF DRAWINGS

FIGS. 1A and 1B are graphs showing a change in a surface charge potential with respect to the number of printing sheets of a photoreceptor having poor initial charging.

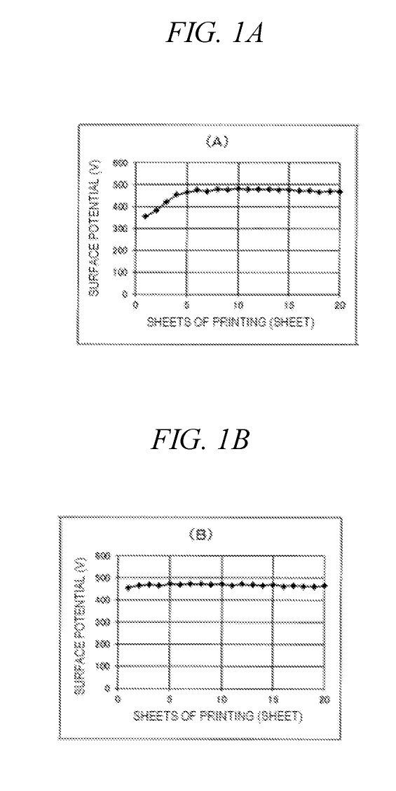

FIG. 2 is a schematic diagram showing a configuration of a main part of one embodiment of an image forming apparatus of the present invention.

### DESCRIPTION OF EMBODIMENTS

Although the embodiments of the present invention are described in detail hereinafter, the present invention is not limited to the following embodiments, and can be implemented by appropriate modifications without departing from the scope of the present invention.

<<Electrophotographic Photoreceptor for Positive Charging>>

Hereinafter, the configuration of the electrophotographic photoreceptor of the present invention is described. The electrophotographic photoreceptor of the present invention includes a single-layer type photosensitive layer as an outermost layer. In order to improve the ability of transporting positive charges, an intermediate layer containing a compound having hole transporting ability and a binder resin can be disposed on a conductive support side.

<Conductive Support>

Although the conductive support is not particularly limited, mainly used as the conductive support is, for example, a metallic material such as aluminum, an aluminum alloy, stainless steel, copper, or nickel, a resinous material to which electrical conductivity has been imparted by adding a conductive powder, e.g., a metal, carbon, or tin oxide powder, or a resin, glass, paper, or the like, having a surface on which a conductive material, e.g., aluminum, nickel, or ITO (indium tin oxide) has been vapor deposited or coated. One selected from these may be used alone, or two or more selected from these may be used in any desired combination and in any desired proportion.

Examples of the shape of the conductive support include a drum-shape, sheet-shape, belt-shape, or the like. Use may be made of a metallic conductive support having a surface coated with a conductive material having a suitable resistance in order to control the conductivity and surface properties thereof, and to coat defects. In a case where a metallic material such as an aluminum alloy is used as a conductive support, this material may be used after an anodized coating film is formed thereon. In the case where an anodized coating film has been formed, the material is preferably subjected to a pore-sealing treatment by a known method.

The surface of the conductive support may be smooth, or may have been roughened by using a special machining method or by performing a grinding treatment. Alternatively, use may be made of a conductive support having a roughened surface obtained by incorporating particles with an appropriate particle diameter into the material for constituting the conductive support. A drawn pipe can be used as such without subjecting the pipe to machining, for the purpose of cost reduction.

<Undercoat Layer>

An undercoat layer may be disposed between the conductive support and the photosensitive layer in order to improve adhesiveness and blocking properties, to hide surface defects of the support, etc. As the undercoat layer, use may be made of a resin or a resin in which particles of a metal oxide or the like is dispersed. In addition, the undercoat layer may be a single layer, or may be a plurality of layers.

Examples of the particles of metal oxide used for the undercoat layer include particles of a metal oxide containing one metallic element, such as titanium oxide, aluminum oxide, silicon oxide, zirconium oxide, zinc oxide, and iron oxide, and particles of a metal oxide containing a plurality of metallic elements, such as calcium titanate, strontium titanate, and barium titanate. One kind of those particles may be used alone, or two or more kinds of those particles may be mixed together and used.

Preferred of these metal oxide particles are titanium oxide and aluminum oxide. Particularly preferred is titanium oxide. The titanium oxide particles may have a surface which has been treated with an inorganic material such as tin oxide, aluminum oxide, antimony oxide, zirconium oxide, and silicon oxide, or with an organic material such as stearic acid, a polyol and a silicone. The crystal form of the titanium oxide particles may be any of rutile, anatase, brookite, and amorphous. The titanium oxide particles may include particles in a plurality of crystal states.

Although metal oxide particles having various particle diameters can be utilized, from the standpoints of properties thereof and fluid stability, preferably used of those particles are metal oxide particles having an average primary-particle diameter of 10 nm to 100 nm, and particularly preferably 10 nm to 50 nm. The average primary-particle diameter can be obtained from a TEM (Transmission Electron Microscope) photograph.

The undercoat layer is preferably formed so as to contain a binder resin and metal oxide particles dispersed therein. Examples of the binder resin to be used in the undercoat layer include: an epoxy resin, a polyethylene resin, a polypropylene resin, an acrylic resin, a methacrylic resin, a polyamide resin, a vinyl chloride resin, a vinyl acetate resin, a phenol resin, a polycarbonate resin, a polyurethane resin, a polyimide resin, a vinylidene chloride resin, a polyvinyl acetal resin, a vinyl chloride-vinyl acetate copolymer, a polyvinyl alcohol resin, a polyacrylic resin, a polyacrylamide resin, a polyvinylpyrrolidone resin, a polyvinylpyridine resin, a water-soluble polyester resin, a cellulose ester resin such as nitrocellulose, a cellulose ether resin, a casein, a gelatin, a polyglutamic acid, starch, starch acetate, amino starch, organic zirconium compounds such as zirconium chelate compounds and zirconium alkoxide compounds, organic titanyl compounds such as titanyl chelate compounds and titanium alkoxide compounds, a silane coupling agent or the like, which are known binder resins. One selected from these may be used alone, or two or more selected from these may be used in any desired combination and in a desired proportion. In addition, these resins may be used together with a hardener to come into a hardened state. Among them, alcohol-soluble copolyamides, modified polyamide, and the like are preferred because of the excellent dispersibility and applicability they exhibit.

The charge generation layer constituting the multilayer type photoreceptor can be used as a substitute for the undercoat layer. In this case, preferably used is an undercoat layer that phthalocyanine pigments, azo pigments, or the like is dispersed in the binder resin to be coated since the electrical properties thereof may be excellent. Among these, more preferably used are phthalocyanine pigments (phthalocyanine compounds) from the standpoint of electrical properties. Preferably used as the binder resin are polyvinyl acetal resins, and particularly preferably used are polyvinyl butyral resins. In this case, it is preferable to mix the above with oxytitanium phthalocyanine showing a distinct peak at a diffraction angle 2θ(±0.2°) of 27.2° in X-ray powder diffractometry using a CuKα line.

Although the ratio of particles to be used in the undercoat layer based on the binder resin can be selected at will, the ratio is preferably in a range of 10 mass % to 500 mass % based on the binder resin, from the standpoints of dispersion stability and applicability.

Although the thickness of the undercoat layer can be selected at will without impairing the effects of the present invention remarkably, the thickness is usually 0.01 μm or more, and preferably 0.1 μm or more, and usually 30 μm or less and preferably 20 μm or less, from the standpoints of improving the electrical properties, the high exposure property, the image properties and the repetition property of the electrophotographic photoreceptor, and of improving the applicability during production. A known antioxidant and the like may be incorporated into the undercoat layer. In order to prevent image defects or the like, pigment particles, resin particles or the like may be contained and used.

<Single-Layer Type Photosensitive Layer>

The single-layer type photosensitive layer is formed using a binder resin in order to secure film strength, in addition to a charge transport material. Specifically, the single-layer type photosensitive layer can be obtained by dissolving or dispersing a charge transport material and various binder resins in a solvent to prepare a coating fluid, and coating the coating fluid onto a conductive support (onto an undercoat layer in a case where the undercoat layer is disposed).

<Charge Generation Material>

The electrophotographic photoreceptor for positive charging of the present invention can contain any charge generation material. Examples of the charge generation material include inorganic photoconductive materials, such as selenium, and alloys thereof, and cadmium sulfide, and organic photoconductive materials such as organic pigments. Preferred of these are organic photoconductive materials, and particularly preferred are organic pigments. Examples of the organic pigments include phthalocyanine pigments, azo pigments, dithioketopyrrolopyrrole pigments, squalene (squarylium) pigments, quinacridone pigments, indigo pigments, perylene pigments, polycyclic quinone pigments, anthanthrone pigments, and benzimidazole pigments. Particularly preferred of those organic pigments are phthalocyanine pigments and azo pigments. In the case of using any of these organic pigments as the charge generation material, the organic pigment is used usually in the form of a dispersion layer in which fine particles thereof have been bound with any of various binder resins.

In the case of using the phthalocyanine pigment as the charge generation material, use may be made specifically of metal-free phthalocyanines, phthalocyanines to which a metal, e.g., copper, indium, gallium, tin, titanium, zinc, vanadium, silicon, germanium, or aluminum, or an oxide, halide, hydroxide or alkoxide thereof has coordinated, these phthalocyanines having respective crystal forms, and phthalocyanine dimers in which oxygen atoms or other atoms are used as crosslinking atoms. Particularly preferred are X-form and τ-form metal-free phthalocyanines, A-form (also called β-form), B-form (also called α-form), D-form (also called Y-form), and the likes of titanyl phthalocyanines (other name: oxytitanium phthalocyanines), vanadyl phthalocyanines, chloroindium phthalocyanines, hydroxyindium phthalocyanines, II-form and the likes of chlorogallium phthalocyanines, V-form and the likes of hydroxygallium phthalocyanines, G-form, I-form, and the likes of μ-oxo-gallium phthalocyanine dimers, and II-form and the likes of μ-oxo-aluminum phthalocyanine dimers, which are crystal forms having high sensitivity.

Particularly preferred of these phthalocyanine compounds are X-form metal-free phthalocyanines, A-form (also called β-form) and B-form (also called α-form) titanyl phthalocyanines, D-form (Y-form) titanyl phthalocyanine characterized by showing a distinct peak at a diffraction angle 2θ(±0.2°) of 27.1° or 27.3° in X-ray powder diffractometry, II-form chlorogallium phthalocyanine, V-form hydroxygallium phthalocyanine, the hydroxygallium phthalocyanine characterized by having a most intense peak at 28.1° or characterized by having no peak at 26.2°, having a distinct peak at 28.1°, and having a half-value width W at 25.9° of 0.1°≤W≤0.4°, and a G-form μ-oxo-gallium phthalocyanine dimer.

A single phthalocyanine compound may be used alone, or a mixture of several phthalocyanine compounds or a phthalocyanine compound in a mixed-crystal state may be used. The state in which phthalocyanine compounds are mixed or the mixed-crystal state may be one obtained by mixing the constituent elements later, or may be one formed in steps for phthalocyanine compound production and treatments, such as synthesis, pigment formation, crystallization, etc. Known as such treatments are an acid pasting treatment, grinding treatment, solvent treatment, and the like. Examples of methods for producing a mixed-crystal state include a method in which two kinds of crystals are mixed together and the resultant mixture is mechanically ground and made amorphous and is then subjected to a solvent treatment to thereby convert the amorphous state into a specific crystalline state, as described in JP-A-H10-48859.

The particle diameter of the charge generation material is usually 1 μm or less, and preferably used are particles having a particle diameter of 0.5 μm or less. The amount of the charge generation material to be dispersed in the photosensitive layer is usually 0.1 parts by mass or more, preferably 0.5 parts by mass or more, and more preferably 1.0 part by mass or more based on 100 parts by mass of the binder resin. In addition, from the standpoint of sensitivity, the amount of the charge generation material to be dispersed in the photosensitive layer is usually 20 parts by mass or less, preferably 15 parts by mass or less, and more preferably 10 parts by mass or less.

<Binder Resin>

In the present invention, although the binder resin contains a polyarylate resin, it can be mixed with other resins and used in the electrophotographic photoreceptor. Here, examples of the other resins used in combination include thermoplastic resins and various thermosetting resins, such as polymethyl methacrylate, polystyrene, vinyl polymers such as polyvinyl chloride and a copolymer thereof, polycarbonate, polyarylate, polyarylate polycarbonate, polysulfone, phenoxy, epoxy and silicone resins. Preferred of these resins are polycarbonate resins.

[Polyarylate Resin]

The structure of the above-described polyarylate resin contained in the photosensitive layer is exemplified below. This example is provided to clarify the gist of the present invention and the present invention is not limited to the exemplified structure unless contrary to the gist of the present invention. The polyarylate resin contained in the photosensitive layer is preferably one containing a repeating structural unit represented by the following General Formula (1b), for example, and can be produced from, for example, a divalent hydroxyaryl component and a dicarboxylic acid component by a known method.

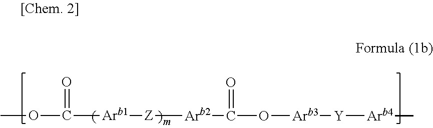

(In Formula (1b), Ar^{b1} to Ar^{b4} each independently represent an arylene group that may have a substituent, Z represents a single bond, an oxygen atom, a sulfur atom, or an alkylene group, m represents an integer of 0 to 2, and Y represents a single bond, an oxygen atom, a sulfur atom, or an alkylene group).

In above Formula (1b), the number of carbon atoms of the arylene group in Ar^{b1} to Ar^{b4} is usually 6 or more, and is usually 20 or less, preferably 10 or less, and more 6. Specific examples of Ar^{b1} to Ar^{b4} include 1,2-phenylene group, 1,3-phenylene group. 1,4-phenylene group, naphthylene group, anthrylene group, phenanthrylene group, or the like. From the standpoint of electrical properties, as an arylene group, preferred is 1,4-phenylene group. One selected from the arylene group may be used alone, or two or more selected from the arylene group may be used in any desired proportion and in any desired combination.

Examples of a substituent that Ar^{b1} to Ar^{b4} may have include an alkyl group, aryl group, halogen group, alkoxy group, or the like. In a case of using a polyester resin as the binder resin for the photosensitive layer, considering the mechanical properties and the solubility to a coating fluid for forming the photosensitive layer, preferred of these are an alkyl group having 1 to 4 carbon atoms and an aryl group having 6 to 12 carbon atoms, and also preferred is an alkoxy group having 1 to 4 carbon atoms. Specifically, as an alkyl group, preferred are a methyl group, an ethyl group, a propyl group, and an isopropyl group; as an aryl group, preferred are a phenyl group and a naphthyl group; and as an alkoxy group, preferred are a methoxy group, ethoxy group, propoxy group, and butoxy group.

In more detail, it is preferable that Ar^{b3} and Ar^{b4} each independently have the number of substituents of 0 to 2, and it is preferable to have a substituent from the standpoint of adhesiveness. Among these, from the standpoint of wear resistance, it is particularly preferable to have the number of substituents of 1. As a substituent, preferred is an alkyl group, and particularly preferred is a methyl group. From the standpoints of electrical properties and wear resistance, in the above Formula (1b), it is preferable that Ar^{b3} and Ar^{b4} are each independently an arylene group having an alkyl group in a case where m is 0. It is preferable that Ar^{b1} and Ar^{b2} each independently have the number of substituents of 0 to 2, and from the standpoint of wear resistance, it is preferable that Ar^{b1} and Ar^{b2} have no substituent.

In the above Formula (1b), Y is a single bond, an oxygen atom, a sulfur atom, or an alkylene group. As an alkylene group, preferred are —CH₂—, —CH(CH₃)—, —C(CH₃)₂—, and cyclohexylene, and more preferred are —CH₂—, —CH(CH₃)—, and —C(CH₃)₂—.

In the above Formula (1 b), Z is a single bond, an oxygen atom, a sulfur atom, or an alkylene group. Among these, it is preferable that Z is an oxygen atom. At this time, it is preferable that m is 0 or 1, and particularly preferably 1.

In a case where m is 1, specific examples of a preferable dicarboxylic acid residue as a structural unit represented by the Formula (1b) include a diphenyl ether-2,2′-dicarboxylic acid residue, a diphenyl ether-2,3′-dicarboxylic acid residue, a diphenyl ether-2,4′-dicarboxylic acid residue, a diphenyl ether-3,3′-dicarboxylic acid residue, a diphenyl ether-3,4′-dicarboxylic acid residue, a diphenyl ether-4,4′-dicarboxylic acid residue, or the like.

Considering convenience in production of the dicarboxylic acid component, among these, more preferred are a diphenyl ether-2,2′-dicarboxylic acid residue, a diphenyl ether-2,4′-dicarboxylic acid residue, and a diphenyl ether-4,4′-dicarboxylic acid residue, and particularly preferred is a diphenyl ether-4,4′-dicarboxylic acid residue.

In a case where m is 0, specific examples of a dicarboxylic acid residue include a phthalic acid residue, an isophthalic acid residue, a terephthalic acid residue, a toluene-2,5-dicarboxylic acid residue, a p-xylene-2,5-dicarboxylic acid residue, a naphthalene-1,4-dicarboxylic acid residue, a naphthalene-2,3-dicarboxylic acid residue, a naphthalene-2,6-dicarboxylic acid residue, a biphenyl-2,2′-dicarboxylic acid residue, a biphenyl-4,4′-dicarboxylic acid residue, or the like.

Among these, preferred are a phthalic acid residue, an isophthalic acid residue, a terephthalic acid residue, a naphthalene-1,4-dicarboxylic acid residue, a naphthalene-2,6-dicarboxylic acid residue, a biphenyl-2,2′-dicarboxylic acid residue, and a biphenyl-4,4′-dicarboxylic acid residue, and particularly preferred are an isophthalic acid residue and a terephthalic acid residue. A plurality of these dicarboxylic acid residues can be used in combination.

In a case where the above polyarylate resin has the above dicarboxylic acid residue as a repeating structural unit represented by the General Formula (1b) and the above other dicarboxylic acid residues, it is preferable that the dicarboxylic acid residue constituting the present invention has a number of repeating units of 70% or more, more preferably 80% or more, and particularly preferably 90% or more. The most preferred is a case of only having the dicarboxylic acid residue constituting the present invention, that is, a case where the dicarboxylic acid residue constituting the present invention has a number of repeating units of 100%.

The viscosity-average molecular weight of the polyarylate resin is not particularly limited, and is usually 10,000 or more, preferably 15,000 or more, and more preferably 20,000 or more, but is usually 300,000 or less, preferably 200,000 or less, and more preferably 100,000 or less. The viscosity-average molecular weight of the polyarylate resin can be measured by the method described below.

[Method for Measuring Viscosity-Average Molecular Weight]

First, the polyarylate resin is dissolved in dichloromethane to prepare a solution having a concentration C of 6.00 g/L. Thereafter, using a Ubbelohde capillary viscometer having a solvent (dichloromethane) flow time t0 of 136.16 seconds, the sample solution is examined for flow time t in a thermostatic water bath set at 20.0° C. The viscosity-average molecular weight My can be calculated according to the following equations.

a=0.438×ηsp+1 (ηsp=(t/t0)−1)

b=100×ηsp/C(C=6.00 (g/L))

η=b/a

Mv=3207×1.2051

<Charge Transport Material>

[Compound Having Electron-Transporting Ability]

It is preferable that the photosensitive layer contains a compound represented by the following Formula (1e) as a compound having electron-transporting ability.

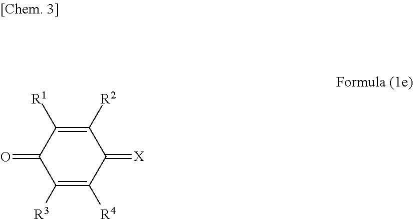

(In Formula (1e), R¹ to R⁴ each independently represent a hydrogen atom, an alkyl group having 1 to 20 carbon atoms that may have a substituent, or an alkenyl group having 1 to 20 carbon atoms that may have a substituent, and R¹ and R², or R¹ and R⁴ may be bonded to each other to form a cyclic structure. X represents an organic residue having a molecular weight of 120 to 250.)

R¹ to R⁴ each independently represent a hydrogen atom, or an alkyl group having 1 to 20 carbon atoms, or an alkenyl group having 1 to 20 carbon atoms that may have a substituent.

Examples of the alkyl group having 1 to 20 carbon atoms that may have a substituent include linear alkyl groups such as a methyl group, ethyl group and hexyl group, branched alkyl groups such as an iso-propyl group, tert-butyl group and tert-amyl group, and cyclic alkyl groups such as a cyclohexyl group and cyclopentyl group. Preferred of these is an alkyl group having 1 to 15 carbon atoms from the standpoint of versatility of the starting materials, more preferred is an alkyl group having 1 to 10 carbon atoms from the standpoint of handleability during production, and even more preferred is an alkyl group having 1 to 5 carbon atoms. From the standpoint of electron-transporting ability, a linear alkyl group or a branched alkyl group is preferably, and among them a methyl group, tert-butyl group, and tert-amyl group are more preferable, and from the standpoint of solubility in organic solvents used in coating fluids, a tert-butyl group and tert-amyl group are even more preferable.

Examples of the alkenyl group having 1 to 20 carbon atoms that ma) have a substituent include linear alkenyl groups such as an ethenyl group, branched alkenyl groups such as a 2-methyl-1-propenyl group, and cyclic alkenyl groups such as a cyclohexenyl group. Preferred of these is a linear alkenyl group having 1 to 10 carbon atoms from the standpoint of the photo-attenuation characteristics of the photoreceptor.

Regarding the substituents R¹ to R⁴, R¹ and R² together, or R³ and R⁴ together may be bonded to form a cyclic structure. From the standpoint of electron mobility, in the cases where both R¹ and R² are alkenyl groups, R¹ and R² may preferably be bonded together to form an aromatic ring, and it is more preferable that both R¹ and R² are ethenyl groups and bonded together to form a benzene ring structure.

In the above Formula (1e), X represents an organic residue having a molecular weight of 120 to 250, and X is preferably an organic residue represented by any one of the following Formulae (2e) to (5e) from the standpoint of the photo-attenuation characteristics of the photoreceptor.

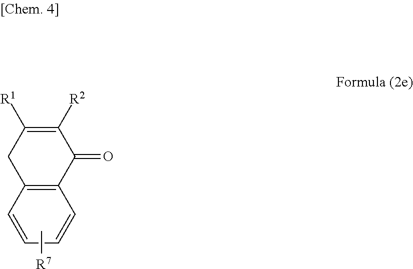

(In Formula (2e), R⁵ to R⁷ each independently represent a hydrogen atom or an alkyl group having 1 to 6 carbon atoms.)

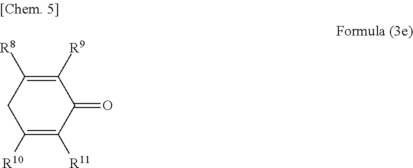

(In Formula (3e), R⁸ to R¹¹ each independently represent a hydrogen atom, halogen atom, or an alkyl group having 1 to 6 carbon atoms.)

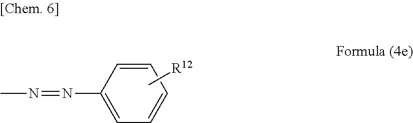

(In Formula (4e), R¹² represents a hydrogen atom, an alkyl group having 1 to 6 carbon atoms, or a halogen atom.)

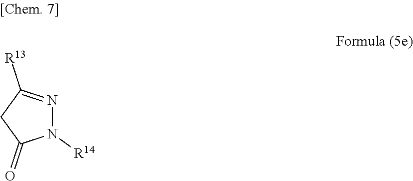

(In Formula (5e), R¹³ and R¹⁴ each independently represent a hydrogen atom, an alkyl group having 1 to 6 carbon atoms, or an aryl group having 6 to 12 carbon atoms.)

Examples of the alkyl group having 1 to 6 carbon atoms in R⁵ to R¹⁴ include linear alkyl groups such as a methyl group, ethyl group and hexyl group, branched alkyl groups such as an iso-propyl group, a tert-butyl group and a tert-amyl group, and cyclic alkyl groups such as a cyclohexyl group. From the standpoint of electron-transporting ability, a methyl group, a tert-butyl group, and a tert-amyl group are more preferable. Examples of the halogen atom include fluorine, chlorine, bromine, and iodine, and from the standpoint of electron-transporting ability, chlorine is preferable. Examples of the aryl group having 6 to 12 carbon atoms include a phenyl group and naphthyl group, and from the standpoint of film property of the photosensitive layer, a phenyl group and naphthyl group are preferable, and a phenyl group is more preferable.

Among the Formulae (2e) to (5e), X is preferably an organic residue represented by Formula (2e) or (3e) from the standpoint of image stability upon repeated image formation, and X is more preferably an organic residue represented by Formula (3e). A compound represented by Formula (1e) may be used alone, or may be used in combination with another compound represented by Formula (1e) having a different structure, or even may be used in combination with another compound having electron-transporting ability. Preferable structures of the compound having electron-transporting ability are exemplified below.

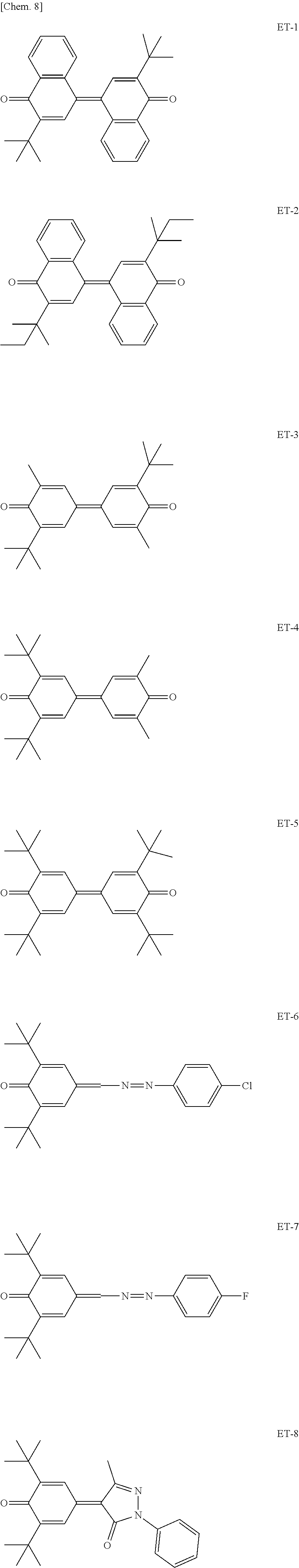

Regarding the proportion between the binder resin and the compound having electron-transporting ability in the photosensitive layer, from the standpoint of preventing optical fatigue, the compound having electron-transporting ability is usually used in an amount of 10 parts by mass or more, preferable 20 parts by mass or more, and more preferable 30 parts by mass or more, based on 100 parts by mass of the binder resin. From the standpoints of stability of the electrical properties, the compound having electron-transporting ability is usually used in an amount of 100 parts by mass or less, preferably 80 parts by mass or less, and more preferably 60 parts by mass or less.

[Compound Having Hole Transporting Ability]

The structure of the compound having hole transporting ability is not limited, and examples thereof include electron-donating materials such as aromatic amine derivatives, stilbene derivatives, butadiene derivatives, hydrazone derivatives, carbazole derivatives, aniline derivatives, enamine derivatives, and compounds where two or more of these compounds bond together, or polymers each including, in the main chain or a side chain thereof, a group constituted of any of these compounds. Preferred among these are aromatic amine derivatives, stilbene derivatives, hydrazone derivatives, enamine derivatives, and compounds where two or more of these compounds bond together. More preferred among these are enamine derivatives, and compounds where two or more of aromatic amines bond together.

Generally, the wider the a conjugated system is, the higher the charge transport performance is. Considering the planarity and the steric effect by the substituent, a structure in which the it conjugated system expands is preferable.

A plurality of compounds having hole transporting ability may also be used in combination. In one or more compounds having hole transporting ability, a compound having hole transporting ability with a higher energy level of HOMO usually has a molecular weight of 450 or more, preferably 500 or more, and still more preferably 600 or more. It is because when the molecular weight of the compound having hole transporting ability is small, bleed-out to the surface of the photosensitive layer is easy to occur, and the bleed-out is promoted by forming a charge transfer complex with the compound having electron-transporting ability.

<Compound C>

In the present invention, in order to improve the charging property of the photoreceptor at a very initial stage of life duration thereof without influencing the electrical properties thereof significantly, the compound C is contained in the photosensitive layer or each layer forming the photosensitive layer.

The compound C has a molecular weight of 500 or less, more preferably 450 or less, more preferably 400 or less, and even more preferably 350 or less. Although the reason of the above is unknown, it is considered that it is because when the molecular weight of the compound C is small, bleed-out of the compound C to the surface of the photoreceptor is easy to occur, and then the bleed-out of the compound having electron-transporting ability is prevented.

In the compound C, the energy level Ch of HOMO obtained from the result of structure optimization calculation according to density function calculation B3LYP/6-31G (d, p) satisfies the Equation (1a).

Ch≤−4.69 (eV) (1a)

The compound C is preferably one that does not hinder the movement of charges in an electrophotographic process. However, when the compound C forms a charge transfer complex with the compound having electron-transporting ability, the bleed-out of the compound having electron-transporting ability to the surface of the photoreceptor is promoted. For the above reason, the compound C is preferably one having low Ch.

It is preferable that Ch is −4.75 eV or less, and more preferably −4.9 eV or less. Incidentally, Ch is usually −7.5 eV or more.

When a compound (compound A) having hole transporting ability with a highest energy level of HOMO in the compound having hole transporting ability is set to have an energy level of HOMO of Ah, and a compound (compound B) having electron transportability with a lowest energy level of LUMO in the compound having electron transportability is set to have an energy level of LUMO of Bl, the following Equations (2a) and (3b) need to be satisfied.

Ah−Ch≥0.10 (eV) Equation (2a)

Bl−Ch≥1.18 (eV) Equation (3a)

In Equation (2a), from the standpoint of obtaining good electrical properties, 0.11 eV or more is preferable, and 0.15 eV or more is more preferable.

In Equation (3a), from the standpoint of preventing formation of the complex, 1.21 eV or more is preferable.

Considering the hole transporting ability, Ah is usually −5.0 eV to −4.0 eV. Considering the electron-transporting ability, Bl is usually −4.5 eV to −3.0 eV.

In a case where the compound having electron-transporting ability forms the charge transfer complex with the compound having hole transporting ability or the compound C, and they are placed under an environment of near Tg or at Tg or more in a drying step or likes, the bleed-out of the compound having electron-transporting ability may be promoted significantly.

When the energy level of LUMO is set to Cl, the compound C preferably satisfy the Equations (4a) and (5a) at the same time, from the standpoint of not impairing the movement of the charges.

Ch≤−4.9 (eV) Equation (4a)

Cl≥−3.2 (eV) Equation (5a)

Cl is preferably −2.0 eV or more, and is usually 1.0 eV or less.

In order to exert the above effects of the present invention sufficiently, it is preferable that the compound C is contained in an amount of 13 mass % or more, more preferably 20 mass % or more, and even more preferably 25 mass % or more, based on the compound having electron-transporting ability. It is usually 200 mass % or less, and is preferably 100 mass % or less, more preferably 75 mass % or less in order to improve the durability of the photoreceptor without reducing the ratio of the binder resin relatively.

In the present invention, the energy level of HOMO E_homo and the energy level of LUMO E_lumo are obtained from a stable structure according to structure optimization calculation using one kind of density functional method, B3LYP (see, A. D. Becke, J. Chem. Phys. 98, 5648(1993), C. Lee. W. Yang, and R G. Parr, Phys. Rev. B37, 785(1988), and B. Miehlich, A. Savin, H. Stoll, and H. Preuss, Chem. Phys. Lett. 157, 200(1989)).

Then, 6-31G (d, p) obtained by adding a polarization function to 6-31G is used as the basis function system (see. R. Ditchfield, W. J. Hehre, and J. A. Pople, J. Chem. Phys. 54, 724(1971); W. J. Hehre, R. Ditchfield, and J. A. Pople, J. Chem. Phys. 56, 2257(1972); P. C. Hariharan and J. A. Pople, Mol. Phys. 27, 209(1974); M. S. Gordon, Chem. Phys. Lett. 76, 163(1980); P. C. Hariharan and J. A. Pople, Theo. Chim. Acta 28, 213(1973); J.-P. Blaudeau, M. P. McGrath, L. A. Curtiss, and L. Radom, J. Chem. Phys. 107, 5016(1997); M. M. Francl, W. J. Pietro, W. J. Hehre, J. S. Binkley, D. J. DeFrees, J. A. Pople, and M. S. Gordon, J. Chem. Phys. 77, 3654(1982); R. C. Binning Jr. and L. A. Curtiss, J. Comp. Chem. 11, 1206(1990); V. A. Rassolov, J. A. Pople, M. A. Ratner, and T. L. Windus, J. Chem. Phys. 109, 1223(1998); and V. A. Rassolov, M. A. Ratner, J. A. Pople, P. C. Redfem, and L. A. Curtiss, J. Comp. Chem. 22, 976(2001)).

In the present invention, the B3LYP calculation using 6-31G (d, p) is described as B3LYP/6-31G (d, p).

In the present invention, the program used for the B3LYP/6-31G (d, p) calculation is Gaussian 03, Revision D. 01 (M. J. Frisch, G. W. Trucks, H. B. Schlegel. G. E. Scuseria, M. A. Robb, J. R Cheeseman, J. A. Montgomery, Jr., T. Vreven, K. N. Kudin. J. C. Burant, J. M. Millam, S. S. lyengar, J. Tomasi, V. Barone, B. Mennucci, M. Cossi, G. Scalmani, N. Rega, G. A. Petersson, H. Nakatsuji, M. Hada, M. Ehara, K. Toyota, R. Fukuda, J. Hasegawa, M. Ishida, T. Nakajima. Y Honda. O. Kitao, H. Nakai, M. Klene, X. Li, J. E. Knox, H. P. Ilratchian, J. B. Cross, V. Bakken, C. Adamo, J. Jaramillo, R. Gomperts, R. E. Stratmann, O. Yazyev, A. J. Austin, R. Cammi, C. Pomelli, J. W. Ochterski, P. Y Ayala. K. Morokuma, G. A. Voth, P. Salvador, J. J. Dannenberg, V. G. Zakrzewski, S. Dapprich, A. D. Daniels, M. C. Strain, O. Farkas, D. K. Malick, A. D. Rabuck, K. Raghavachari, J. B. Foresman, J. V. Ortiz, Q. Cui, A. G. Baboul, S. Clifford, J. Cioslowski, B. B. Stefanov, G. Liu, A. Liashenko. P. Piskorz, I. Komaromi, R. L. Martin, D. J. Fox, T. Keith, M. A. Al-Laham, C. Y. Peng, A. Nanayakkara. M. Challacombe, P. M. W. Gill, B. Johnson, W. Chen, M. W. Wong, C. Gonzalez, and J. A. Pople, Gaussian, Inc., Wallingford Conn., 2004.).

Hereinafter, examples of the compound and the molecular weight thereof, and the values of energy levels of the HOMO and LUMO are exemplified. However, the compound having hole transporting ability, the compound having electron-transporting ability, and the compound C according to the present invention are not limited thereto. Incidentally, Me represents a methyl group, Et represents an ethyl group, and tBu represents a tert-butyl group.

TABLE 1

| Compound | Molecular weighr | E_homo (eV) | E_lumo (eV) |
|---|---|---|---|
| 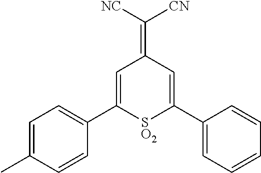 [SMILES: Cc1ccc(C2=CC(=C(C#N)C#N)C=C(c3ccccc3)S2(=O)=O)cc1] | 358.42 | −6.67 | −3.73 |
| 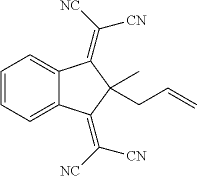 [SMILES: C=CCC1(C)C(=C(C#N)C#N)c2ccccc2C1=C(C#N)C#N] | 296.33 | −7.22 | −3.62 |
| 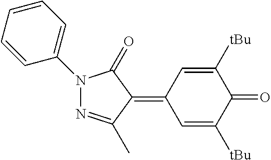 [SMILES: CC1=NN(c2ccccc2)C(=O)C1=C1C=C(C(C)(C)C)C(=O)C(C(C)(C)C)=C1] | 376.50 | −5.78 | −3.61 |
| 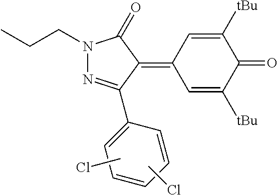 | 505.52 | −6.12 | −3.55 |
| 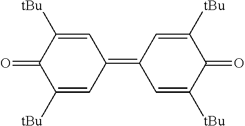 [SMILES: CC(C)(C)C1=CC(=C2C=C(C(C)(C)C)C(=O)C(C(C)(C)C)=C2)C=C(C(C)(C)C)C1=O] | 408.63 | −6.04 | −3.52 |
| 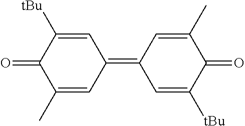 [SMILES: CC1=C/C(=C2/C=C(C)C(=O)C(C(C)(C)C)=C2)C=C(C(C)(C)C)C1=O] | 324.46 | −6.04 | −3.51 |
| 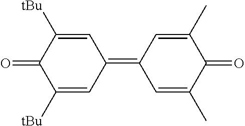 [SMILES: CC1=CC(=C2C=C(C(C)(C)C)C(=O)C(C(C)(C)C)=C2)C=C(C)C1=O] | 324.16 | −6.01 | −3.51 |
| 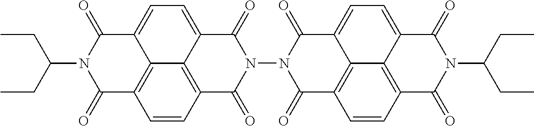 [SMILES: CCC(CC)N1C(=O)c2ccc3c4c(ccc(c24)C1=O)C(=O)N(N1C(=O)c2ccc4c5c(ccc(c25)C1=O)C(=O)N(C(CC)CC)C4=O)C3=O] | 670.68 | −7.09 | −3.49 |
| 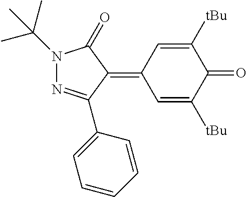 [SMILES: CC(C)(C)C1=CC(=C2C(=O)N(C(C)(C)C)N=C2c2ccccc2)C=C(C(C)(C)C)C1=O] | 418.58 | −5.86 | −3.42 |
| 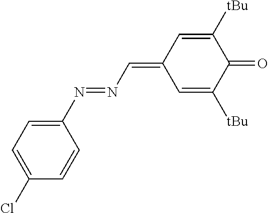 [SMILES: CC(C)(C)C1=CC(=C/N=N/c2ccc(Cl)cc2)C=C(C(C)(C)C)C1=O] | 356.89 | −6.09 | −3.31 |
| 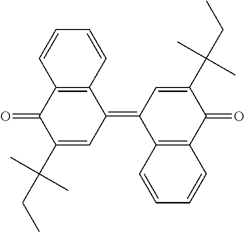 [SMILES: CCC(C)(C)C1=C/C(=C2/C=C(C(C)(C)CC)C(=O)c3ccccc32)c2ccccc2C1=O] | 424.58 | −5.72 | −3.33 |
| 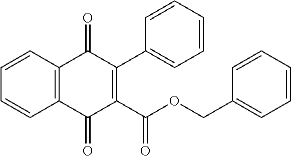 [SMILES: O=C(OCc1ccccc1)C1=C(c2ccccc2)C(=O)c2ccccc2C1=O] | 368.39 | −6.60 | −3.24 |
| 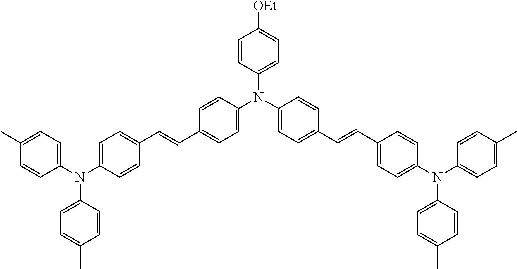 | 884.16 | −4.35 | −1.32 |
| 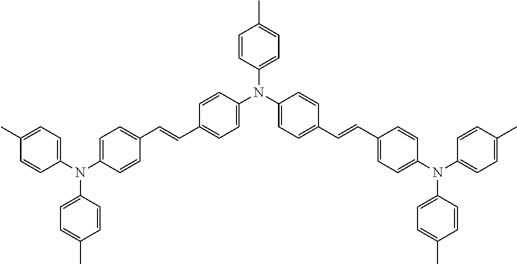 | 854.13 | −4.40 | −1.35 |
| 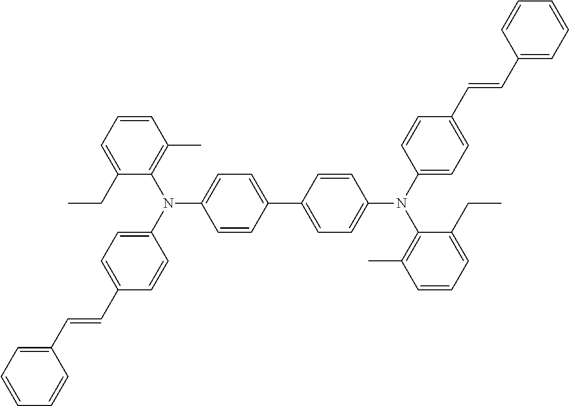 [SMILES: CCc1cccc(C)c1N(c1ccc(/C=C/c2ccccc2)cc1)c1ccc(-c2ccc(N(c3ccc(/C=C/c4ccccc4)cc3)c3c(C)cccc3CC)cc2)cc1] | 777.05 | −4.66 | −1.37 |
| 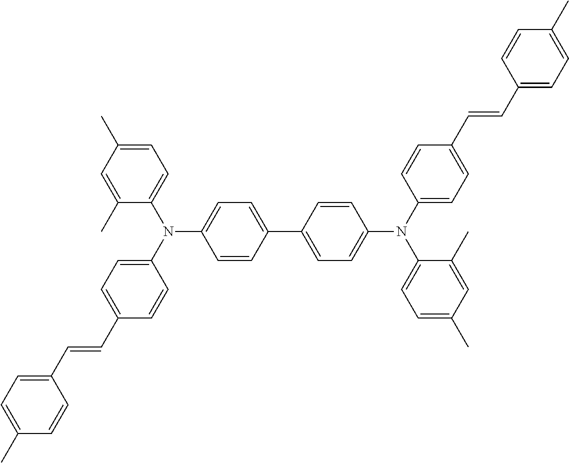 [SMILES: Cc1ccc(/C=C/c2ccc(N(c3ccc(-c4ccc(N(c5ccc(/C=C/c6ccc(C)cc6)cc5)c5ccc(C)cc5C)cc4)cc3)c3ccc(C)cc3C)cc2)cc1] | 777.05 | −4.57 | −1.27 |
| 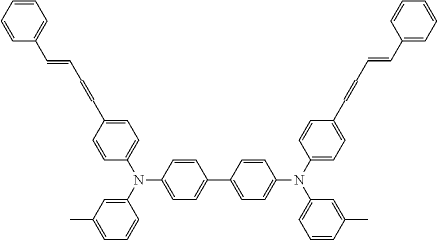 [SMILES: Cc1cccc(N(c2ccc(C=C/C=C/c3ccccc3)cc2)c2ccc(-c3ccc(N(c4ccc(C=C/C=C/c5ccccc5)cc4)c4cccc(C)c4)cc3)cc2)c1] | 773.02 | −4.61 | −1.61 |
| 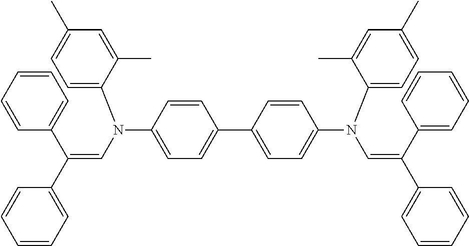 [SMILES: Cc1ccc(N(C=C(c2ccccc2)c2ccccc2)c2ccc(-c3ccc(N(C=C(c4ccccc4)c4ccccc4)c4ccc(C)cc4C)cc3)cc2)c(C)c1] | 748.99 | −4.62 | −0.93 |
| 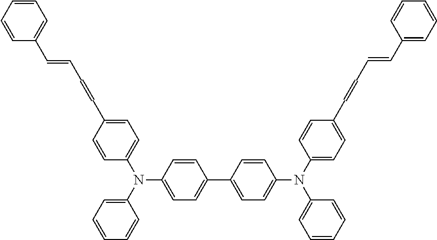 [SMILES: C(=Cc1ccc(N(c2ccccc2)c2ccc(-c3ccc(N(c4ccccc4)c4ccc(C=C/C=C/c5ccccc5)cc4)cc3)cc2)cc1)/C=C/c1ccccc1] | 744.96 | −4.64 | −1.63 |
| 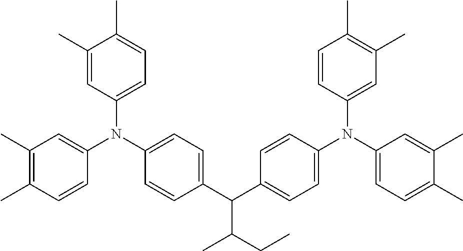 | 670.97 | −4.60 | −0.26 |
| 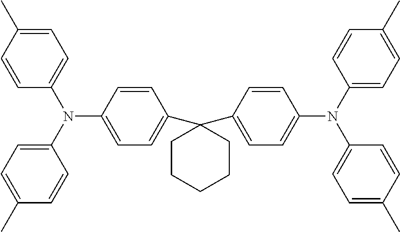 [SMILES: Cc1ccc(N(c2ccc(C)cc2)c2ccc(C3(c4ccc(N(c5ccc(C)cc5)c5ccc(C)cc5)cc4)CCCCC3)cc2)cc1] | 626.87 | −4.66 | −0.30 |
| 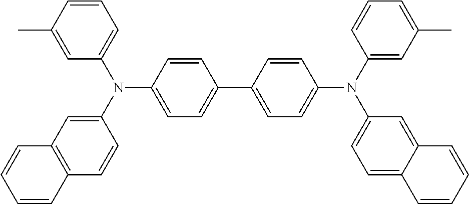 [SMILES: Cc1cccc(N(c2ccc(-c3ccc(N(c4cccc(C)c4)c4ccc5ccccc5c4)cc3)cc2)c2ccc3ccccc3c2)c1] | 618.79 | −4.69 | −105 |
| 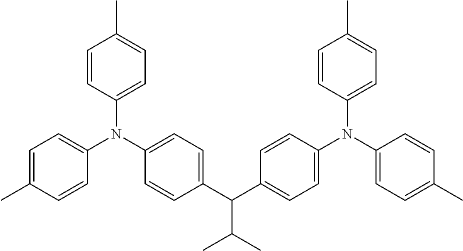 | 600.83 | −4.68 | −0.34 |
| 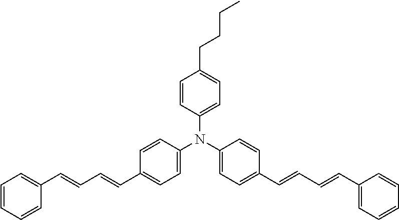 [SMILES: CCCCc1ccc(N(c2ccc(/C=C/C=C/c3ccccc3)cc2)c2ccc(/C=C/C=C/c3ccccc3)cc2)cc1] | 557.78 | −1.63 | −1.71 |
| 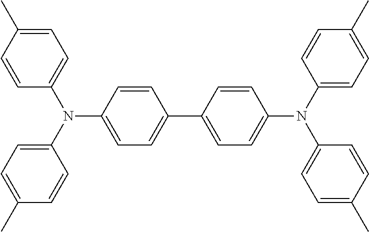 [SMILES: Cc1ccc(N(c2ccc(C)cc2)c2ccc(-c3ccc(N(c4ccc(C)cc4)c4ccc(C)cc4)cc3)cc2)cc1] | 544.73 | −4.55 | −0.66 |
| 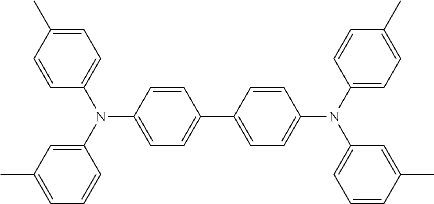 | 544.73 | −1.59 | −0.69 |
| 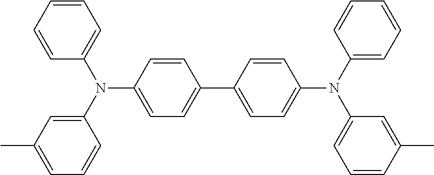 | 516.67 | −4.69 | −0.79 |
| 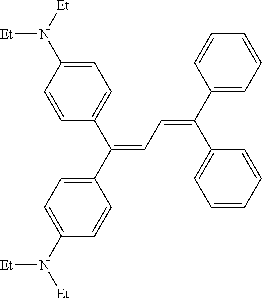 [SMILES: CCN(CC)c1ccc(C(=CC=C(c2ccccc2)c2ccccc2)c2ccc(N(CC)CC)cc2)cc1] | 500.72 | −4.33 | −1.13 |
| 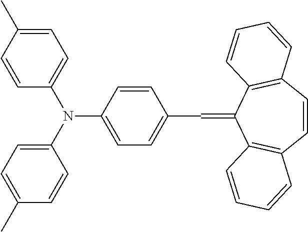 [SMILES: Cc1ccc(N(c2ccc(C)cc2)c2ccc(C=C3c4ccccc4C=Cc4ccccc43)cc2)cc1] | 475.62 | −4.69 | −1.12 |
| 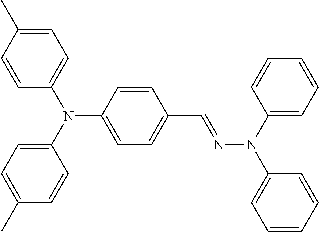 [SMILES: Cc1ccc(N(c2ccc(C)cc2)c2ccc(/C=N/N(c3ccccc3)c3ccccc3)cc2)cc1] | 467.60 | −4.56 | −0.94 |
| 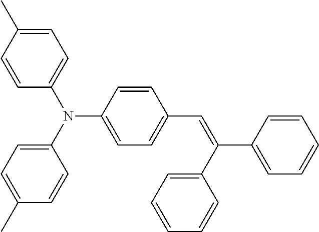 [SMILES: Cc1ccc(N(c2ccc(C)cc2)c2ccc(C=C(c3ccccc3)c3ccccc3)cc2)cc1] | 451.60 | −4.68 | −1.19 |
| 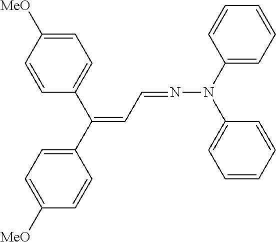 [SMILES: COc1ccc(C(=CC=NN(c2ccccc2)c2ccccc2)c2ccc(OC)cc2)cc1] | 434.53 | −4.62 | −1.14 |
| 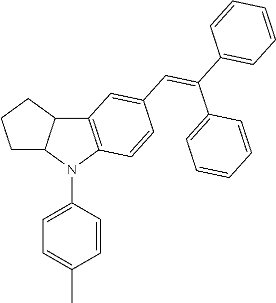 [SMILES: Cc1ccc(N2c3ccc(C=C(c4ccccc4)c4ccccc4)cc3C3CCCC32)cc1] | 427.58 | −4.61 | −1.08 |
| 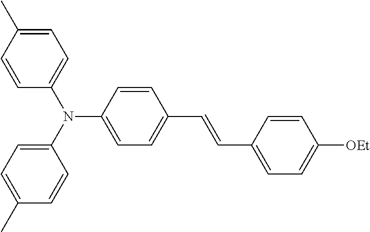 [SMILES: CCOc1ccc(/C=C/c2ccc(N(c3ccc(C)cc3)c3ccc(C)cc3)cc2)cc1] | 419.56 | −4.58 | −1.11 |
| 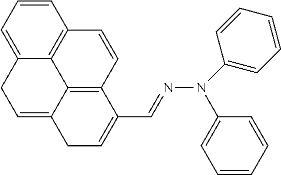 [SMILES: C1=C(/C=N/N(c2ccccc2)c2ccccc2)c2ccc3cccc4c3c2C(=CC4)C1] | 398.50 | −4.82 | −1.69 |
| 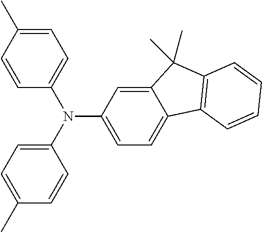 [SMILES: Cc1ccc(N(c2ccc(C)cc2)c2ccc3c(c2)C(C)(C)c2ccccc2-3)cc1] | 389.53 | −4.70 | −0.76 |
| 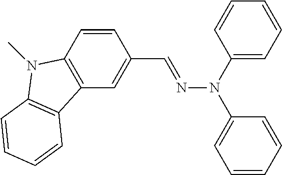 [SMILES: Cn1c2ccccc2c2cc(/C=N/N(c3ccccc3)c3ccccc3)ccc21] | 375.47 | −4.72 | −0.73 |
| 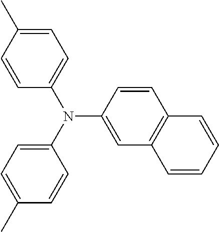 [SMILES: Cc1ccc(N(c2ccc(C)cc2)c2ccc3ccccc3c2)cc1] | 323.43 | −1.79 | −0.94 |
| 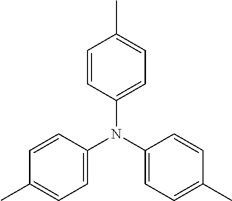 | 287.40 | −4.72 | −0.25 |
| 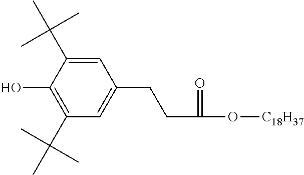 | 530.88 | −5.61 | 0.15 |
| 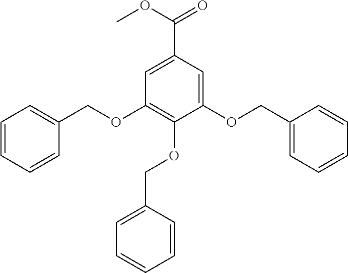 [SMILES: COC(=O)c1cc(OCc2ccccc2)c(OCc2ccccc2)c(OCc2ccccc2)c1] | 454.52 | −6.42 | −1.19 |
| 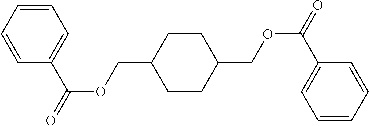 [SMILES: O=C(OCC1CCC(COC(=O)c2ccccc2)CC1)c1ccccc1] | 352.43 | −7.02 | −1.20 |
| 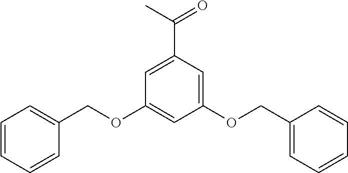 [SMILES: CC(=O)c1cc(OCc2ccccc2)cc(OCc2ccccc2)c1] | 332.40 | −6.12 | −1.48 |
| 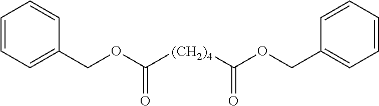 | 326.39 | −6.75 | −0.33 |
| 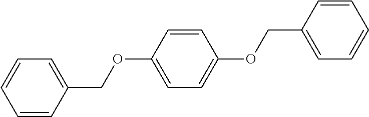 [SMILES: c1ccc(COc2ccc(OCc3ccccc3)cc2)cc1] | 290.36 | −5.39 | −0.20 |
| 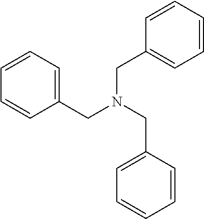 [SMILES: c1ccc(CN(Cc2ccccc2)Cc2ccccc2)cc1] | 287.41 | −5.93 | −0.26 |
| 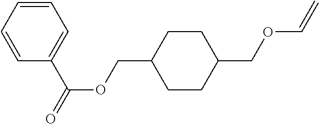 [SMILES: C=COCC1CCC(COC(=O)c2ccccc2)CC1] | 274.36 | −5.98 | −1.19 |
| 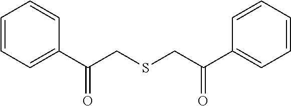 [SMILES: O=C(CSCC(=O)c1ccccc1)c1ccccc1] | 270.35 | −6.34 | −1.94 |
| 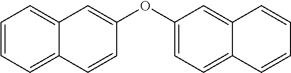 [SMILES: c1ccc2cc(Oc3ccc4ccccc4c3)ccc2c1] | 270.33 | −5.60 | −1.20 |
| 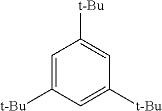 [SMILES: CC(C)(C)c1cc(C(C)(C)C)cc(C(C)(C)C)c1] | 246.44 | −6.11 | 0.17 |
| 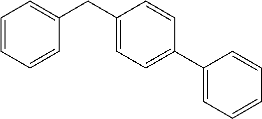 [SMILES: c1ccc(Cc2ccc(-c3ccccc3)cc2)cc1] | 241.34 | −5.91 | −0.69 |
| 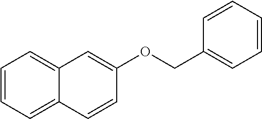 [SMILES: c1ccc(COc2ccc3ccccc3c2)cc1] | 231.30 | −5.72 | −0.99 |
| 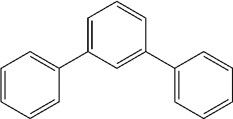 [SMILES: c1ccc(-c2cccc(-c3ccccc3)c2)cc1] | 230.31 | −5.98 | −0.84 |
| 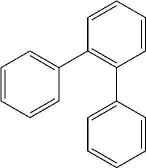 [SMILES: c1ccc(-c2ccccc2-c2ccccc2)cc1] | 230.31 | −5.91 | −0.71 |
| 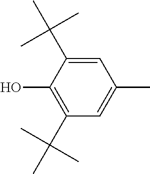 [SMILES: Cc1cc(C(C)(C)C)c(O)c(C(C)(C)C)c1] | 220.36 | −5.18 | 0.20 |

<Other Additives>

The photosensitive layer may contain known additives such as an antioxidant, plasticizer, ultraviolet absorber, electron-attracting compound, leveling agent, visible-light-shielding agent and space filler for the purposes of enhancing the film-forming properties, flexibility, applicability, contamination resistance, gas resistance, light resistance, and the like. Furthermore, particles formed of a fluorine-based resin, silicone resin, polyethylene resin, or the like, or particles of an inorganic compound may be contained for the purposes of reducing the frictional resistance or wear of the surface of the photoreceptor, heightening the efficiency of toner transfer from the photoreceptor to a transfer belt or to paper, and the like.

<Methods for Forming Each Layer>

Each layer that constitutes the above-described photoreceptor may be formed by repeatedly and successively performing application and drying steps, in which a coating fluid obtained by dissolving or dispersing, in a solvent, substances to be contained is applied to a conductive support by a known method, such as dip coating, spray coating, nozzle coating, bar coating, roll coating, or blade coating, and dried to form each layer.

Although solvents or dispersion medium to be used in preparation of the coating fluid is not limited to particular solvents or dispersion media, specific examples thereof include alcohols such as methanol, ethanol, propanol, and 2-methoxyethanol, ethers such as tetrahydrofuran, 1,4-dioxane, and dimethoxyethane, esters such as methyl formate, ethyl acetate, ketones such as acetone, methyl ethyl ketone, cyclohexanone, and 4-methoxy-4-methyl-2-pentanone, aromatic hydrocarbons such as benzene, toluene, and xylene, chlorinated hydrocarbons such as dichloromethane, chloroform, 1,2-dichloroethane, 1,1,2-trichloroethane, 1,1,1-trichloroethane, tetrachloroethane, 1,2-dichloropropane, and trichloroethylene, nitrogen-containing compounds such as n-butylamine, isopropanolamine, diethylamine, triethanolamine, ethylenediamine, and triethylenediamine, and aprotic polar solvents such as acetonitrile, N-methylpyrrolidone, N,N-dimethylformamide, and dimethyl sulfoxide. One selected from these may be used alone, or two or more selected from these may be used in any desired combination.

Although the amount of the solvent or dispersion medium to be used is not particularly limited, the amount thereof is preferably adjusted, as appropriate, in accordance with the intended purpose of each layer and nature of the selected solvent and dispersion media so as to set properties such as the solid content concentration or viscosity of the coating fluid, to be in desired ranges.

For example, in a case of a single-layer type photoreceptor, the solid content concentration of the coating fluid is usually in a range of 5 mass % or more, preferably 10 mass % or more, and is usually in a range of 40 mass % or less, preferably 35 mass % or less. In addition, the viscosity of the coating fluid under a temperature in use is usually in a range of 10 mPa·s or more, more preferably 50 mPa·s or more, and is usually in a range of 500 mPa·s or less, more preferably 400 mPa·s or less.

Regarding the drying of the coating fluid, it is preferable that after a touch drying at room-temperature, the coating fluid is dried with heating in a temperature range of, usually, 30° C. to 200° C. for 1 minute to 2 hours either in a stationary atmosphere or with air blowing. The heating temperature may be constant, or the heating for drying may be performed while changing the heating temperature.

<Cartridge and Image Forming Apparatus>

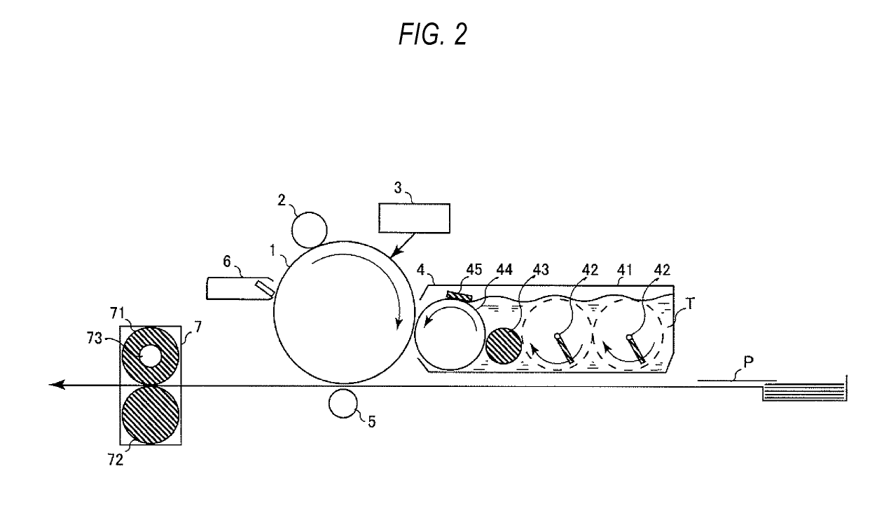

Next, description regarding an embodiment of an image forming apparatus using the electrophotographic photoreceptor of the present invention (image forming apparatus of the present invention) will be provided with reference to FIG. 2, which illustrates the configuration of main components of the apparatus. However, embodiments of the present invention are not limited to the following description, and the embodiments can be freely modified without departing from the spirit and scope of the present invention.

As shown in FIG. 2, the image forming apparatus includes an electrophotographic photoreceptor 1, a charging device 2, an exposure device 3, and a developing device 4, and may further include, as necessary, a transfer device 5, a cleaning device 6, and a fixing device 7.

The electrophotographic photoreceptor 1 is not particularly limited as long as it is an electrophotographic photoreceptor according to the present invention. FIG. 2 shows, as an example thereof, a drum-shaped photoreceptor in which the above-described photosensitive layer is formed on a surface of a cylindrical conductive support. The charging device 2, the exposure device 3, the developing device 4, the transfer device 5 and the cleaning device 6 are respectively disposed along an outer peripheral surface of the electrophotographic photoreceptor 1.

The charging device 2, which is the one that charges the electrophotographic photoreceptor 1, uniformly charges a surface of the electrophotographic photoreceptor 1 to a predetermined potential. Examples of typical charging devices include non-contact corona charging devices such as a corotron and scorotron, or contact charging devices (direct charging devices) that charges the photoreceptor by bringing a charging member to which a voltage is being applied, into contact with the surface of the photoreceptor. Examples of the contact charging devices include charging rollers and charging brushes.

The charging device shown in FIG. 2, as an example of the charging device 2, is a roller type-charging device (charging roller). Charging rollers are typically produced by integrally molding a resin and a plasticizer with a metallic shaft and may have a multilayer structure as necessary. As the voltage to be applied for the charging, a direct-current voltage only can be used or an alternating current superimposed on a direct current is also usable.

The exposure device 3 is not particularly limited as long as it is an exposure device that is capable of exposing the electrophotographic photoreceptor 1 to light and forming an electrostatic latent image on the photosensitive surface of the electrophotographic photoreceptor 1. Specific examples thereof include a halogen lamp, fluorescent lamp, laser such as semiconductor laser or He—Ne laser, and LED. Exposure may be performed by an internal photoreceptor exposure technique, or the like. Although the wavelength of the exposing light can be selected at will, use can be made of, for example, monochromatic light having a wavelength of 780 nm, monochromatic light having a slightly short wavelength in a range of 600 nm to 700 nm, monochromatic light having a short wavelength in a range of 380 nm 500 nm, or the like.

Although a toner T can be selected at will, use can be made of polymerization toners obtained by methods such as suspension polymerization, emulsion polymerization, and the like in addition to powdery toners. In particular, in a case where polymerization toners are used, preferred are toners having a small particle diameter of around 4 μm to 8 μm, and use can be made of the toner particles having various shapes from a nearly spherical shape to bar-shaped shape apart from a sphere. Polymerization toners, which are excellent in terms of uniformity in charging and transferability, are preferably used for increasing image quality.

The transfer device 5 is not limited to a particular kind, and use can be made of devices using any technique such as an electrostatic transfer technique, pressure transfer technique, adhesive transfer technique, or the like, e.g., corona transfer, roller transfer, or belt transfer. Herein, it is assumed that the transfer device 5 includes a transfer charger, a transfer roller, and a transfer belt configured to face the electrophotographic photoreceptor 1. This transfer device 5 applies a predetermined voltage (transfer voltage) in a polarity opposite to the charge potential of the toner T and thereby transfers a toner image formed on the electrophotographic photoreceptor 1 onto a recording paper (paper and medium) P.

The type of the cleaning device 6 is not particularly limited, and use can be made of any cleaning device such as a brush cleaner, magnetic brush cleaner, electrostatic brush cleaner, magnetic roller cleaner, blade cleaner, or the like. The cleaning device 6 scrapes off residual toners attached to the photoreceptor 1 with a cleaning member to collect the residual toners. However, in a case where the residual toners on the surface of the photoreceptor are either small or almost non-existent, the cleaning device 6 may be omitted.

The electrophotographic apparatus configured as such records an image as follows. That is, first, the charging device 2 charges a surface (photosensitive surface) of the photoreceptor 1 to a predetermined potential (for example, 600 V). At this time, the charging device 2 may charge the photosensitive surface of the photoreceptor using a direct-current voltage or may charge the same using an alternate-current voltage superimposed with a direct-current voltage.

Next, the charged photosensitive surface of the photoreceptor 1 is exposed to light by the exposure device 3 in accordance with an image to be recorded to form an electrostatic latent image on the photosensitive surface. Subsequently, the developing device 4 develops the electrostatic latent image formed on the photosensitive surface of the photoreceptor 1.

The developing device 4 forms the toner T supplied by a supply roller 43 into a thin layer using a regulating member (developing blade) 45 and charges the toner T to a predetermined polarity (here, the same polarity as that of the charge potential of the photoreceptor 1: positive polarity) by means of frictional electrification, transfers the toner while supporting the toner with a developing roller 44, and brings the toner into contact with the surface of the photoreceptor 1.

When the charged toner T supported with the developing roller 44 comes into contact with the surface of the photoreceptor 1, a toner image corresponding to the electrostatic latent image is formed on the photosensitive surface of the photoreceptor 1. Subsequently, the toner image is transferred by the transfer device 5 onto the recording paper P. Thereafter, the toners remaining on the photosensitive surface of the photoreceptor 1 without being transferred are removed by the cleaning device 6.

After the transfer of the toner image onto the recording paper P, the recording paper P is made to pass through the fixing device 7 such that the toner image is thermally fixed onto the recording paper P, whereby obtaining a final image.

In addition to the above-described configuration, the image forming apparatus may be configured, for example, to be capable of performing a charge erase step. The charge erase step is a step of carrying out eliminating the charges by exposing the electrophotographic photoreceptor to light, and as a charge removal device, a fluorescent lamp or LED may, for example, be used. Further, regarding the intensity of the light used in the charge erase step, light having exposure energy at least three times the exposure light is frequently used. From the standpoints of miniaturization and energy conservation, the charge erase step is preferably omitted.

The image forming apparatus may further be modified such that the image forming apparatus is configured, for example, to be capable of performing a pre-exposure step or an auxiliary charging step, or to be capable of offset printing, or further may be configured as a full-color tandem system employing multiple kinds of toners.

In the present invention, one or two or more of the charging device 2, the exposure device 3, the developing device 4, the transfer device 5, the cleaning device 6, and the fixing device 7 may be combined with the electrophotographic photoreceptor 1 to configure an integrated cartridge (hereinafter, referred as “electrophotographic photoreceptor cartridge” as appropriate) so that this electrophotographic photoreceptor cartridge can be mounted on and demounted from the main body of an electrophotographic apparatus such as a copier or a laser-beam printer.

### Example

Hereinafter, embodiments of the present invention will be described more specifically with reference to examples. It is to be noted that the following examples are presented for the purpose of explaining the present invention in detail, and the present invention is not limited to the following examples, and can be arbitrarily modified and carried out within the scope not departing from the gist of the invention. In the following Examples and Comparative Examples, the term “parts” means “parts by mass” unless otherwise specified.

<Preparation of Electrophotographic Photoreceptor>

### Example 1

Ten parts by mass of Y-type oxytitanium phthalocyanine was mixed with 150 parts by mass of 1,2-dimethoxyethane. This mixture was subjected to a pulverization/dispersion treatment with a sand grinding mill, thereby obtaining a pigment dispersion. 160 parts by mass of the pigment dispersion thus obtained was mixed with 100 parts by mass of a 5 mass % 1,2-dimethoxyethane solution of polyvinyl butyral (trade name, #6000C; manufactured by Denki Kagaku Kogyo K.K.) and an appropriate amount of 4-methoxy-4-methyl-2-pentanone so as to prepare a coating fluid for undercoating with a solid content concentration of 4.0 mass % 6. A cylinder made of an aluminum alloy having an outer diameter of 30 mm, a length of 340 mm, and a thickness of 0.75 mm, the surface of which was machined roughly, was dip coated with the coating fluid for undercoating to form an undercoat layer. The thickness of the obtained undercoat layer after drying was found to be 0.3 μm.

Next, 4.5 parts by mass of X-form metal-free phthalocyanine was dispersed in 60 parts by mass of toluene with a sand grinding mill.

On the other hand, 60 parts by mass of a compound having hole transporting ability represented by the following Structural Formula (C-1), 40 parts by mass of a compound having electron-transporting ability represented by the following Structural Formula (ET-2), 15 parts by mass of a compound represented by the following Structural Formula (C-4) (hereinafter, also called compound C4), and 100 parts by mass of a polyarylate resin represented by the following Structural Formula (A-1) (hereinafter, also called binder resin A1) [viscosity-average molecular weight: Mv=41,000] were dissolved in a mixed solvent of 590 parts by mass of tetrahydrofuran and 90 parts by mass of toluene.

Subsequently, 0.05 parts of silicone oil was added thereto as a leveling agent. Into this, the above-described dispersion was further added, and the mixture thus obtained was uniformly mixed with a homogenizer so as to obtain a coating fluid for a single-layer type photosensitive layer. The coating fluid for a single-layer type photosensitive layer prepared as such was applied onto the undercoat layer to form a film having a thickness of 30 μm after drying, and after blowing air drying at 100° C. for 30 minutes, a photoreceptor was obtained which was a single-layer type electrophotographic photoreceptor for positive charging.

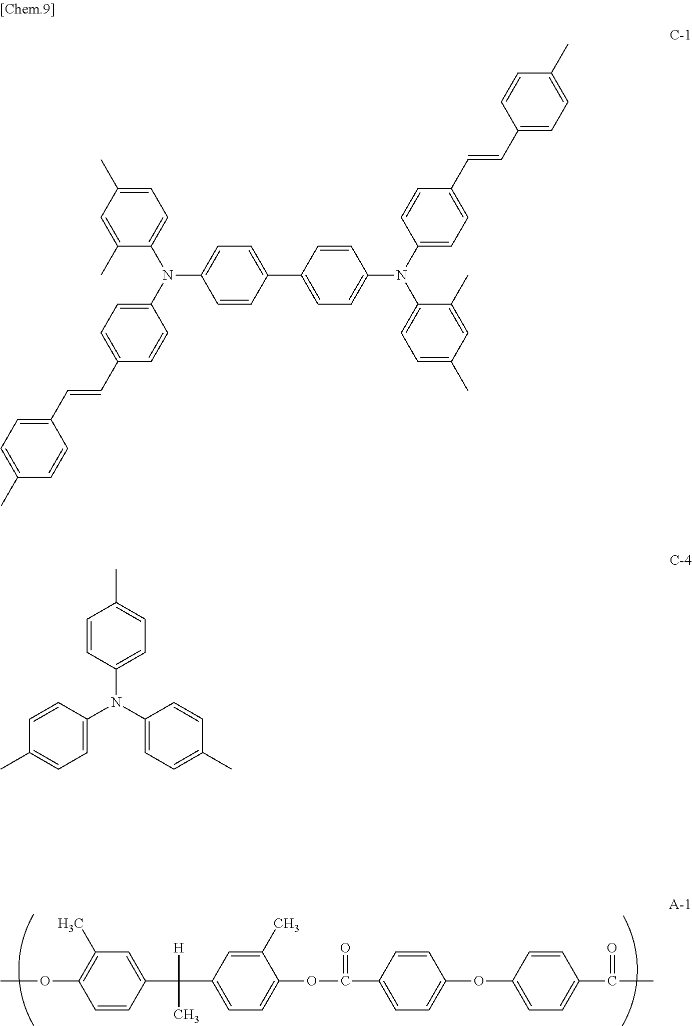

### Example 2

The photoreceptor was produced in the same manner as in Example 1 except that the number of parts of the compound C4 was changed to 5 parts by mass.

### Example 3

The photoreceptor was produced in the same manner as in Example 1 except that the compound C4 was changed to a compound represented by the following Structural Formula (C-5).

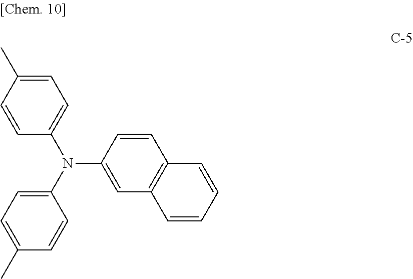 [SMILES: Cc1ccc(N(c2ccc(C)cc2)c2ccc3ccccc3c2)cc1]

### Example 4

The photoreceptor was produced in the same manner as in Example 3 except that the number of parts of the compound represented by the above Structural Formula (C-5) was changed to 5 parts by mass.

### Example 5

The photoreceptor was produced in the same manner as in Example 1 except that the compound C4 was changed to a compound represented by the following Structural Formula (C-6).

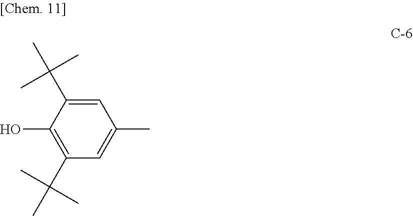 [SMILES: Cc1cc(C(C)(C)C)c(O)c(C(C)(C)C)c1]

### Example 6

The photoreceptor was produced in the same manner as in Example 5 except that the number of parts of the compound represented by the above Structural Formula (C-6) was changed to 5 parts by mass.

### Example 7

The photoreceptor was produced in the same manner as in Example 1 except that the compound C4 was changed to a compound represented by the following Structural Formula (C-7).

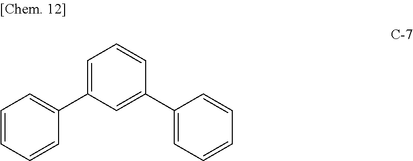 [SMILES: c1ccc(-c2cccc(-c3ccccc3)c2)cc1]

### Example 8

The photoreceptor was produced in the same manner as in Example 1 except that the compound C4 was changed to a compound represented by the following Structural Formula (C-8).

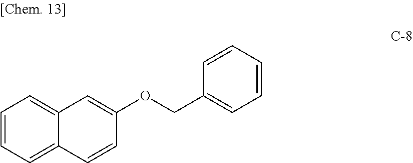 [SMILES: c1ccc(COc2ccc3ccccc3c2)cc1]

### Example 9

The photoreceptor was produced in the same manner as in Example 1 except that the compound C4 was changed to a compound represented by the following Structural Formula (C-9).

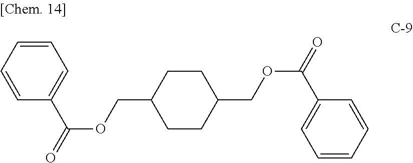 [SMILES: O=C(OCC1CCC(COC(=O)c2ccccc2)CC1)c1ccccc1]

### Example 10

The photoreceptor was produced in the same manner as in Example 1 except that the compound having electron-transporting ability was changed to the compound having electron-transporting ability represented by the above Structural Formula (ET-4).

### Example 11

The photoreceptor was produced in the same manner as in Example 1 except that the compound having hole transporting ability was changed to a compound having hole transporting ability represented by the following Structural Formula (C-2).

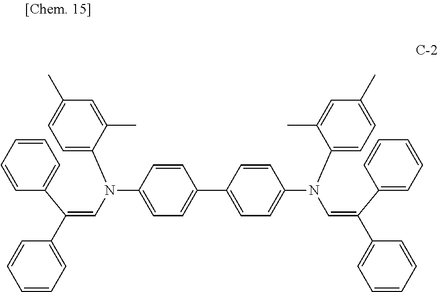 [SMILES: Cc1ccc(N(C=C(c2ccccc2)c2ccccc2)c2ccc(-c3ccc(N(C=C(c4ccccc4)c4ccccc4)c4ccc(C)cc4C)cc3)cc2)c(C)c1]

### Example 12

The photoreceptor was produced in the same manner as in Example 11 except that the compound C4 was changed to a compound represented by the following Structural Formula (C-10).

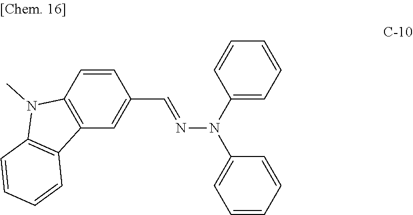 [SMILES: Cn1c2ccccc2c2cc(/C=N/N(c3ccccc3)c3ccccc3)ccc21]

### Example 13

The photoreceptor was produced in the same manner as in Example 1 except that the binder resin A1 was changed to polyarylate represented by the following Structural Formula (A-2).

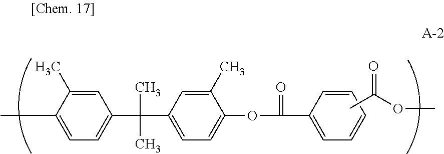

### Comparative Example 1

The photoreceptor was produced in the same manner as in Example 1 except that the binder resin A1 was changed to polycarbonate represented by the following Structural Formula (P-1).

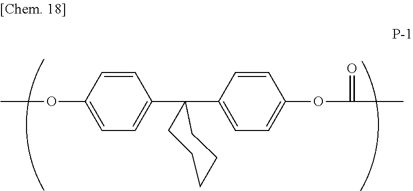

### Comparative Example 2

The photoreceptor was produced in the same manner as in Example 1 except that the compound C4 was changed to a compound represented by the following Structural Formula (C-11).

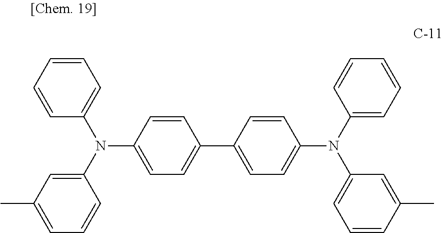

### Comparative Example 3

The photoreceptor was produced in the same manner as in Example 1 except that the compound C4 was changed to a compound represented by the following Structural Formula (C-12).

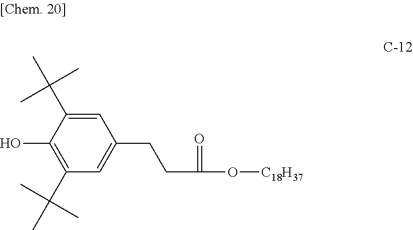

### Comparative Example 4

The photoreceptor was produced in the same manner as in Example 1 except that the compound having hole transporting ability was changed to a compound having hole transporting ability represented by the following Structural Formula (C-3).

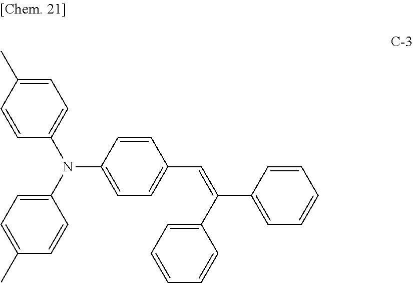 [SMILES: Cc1ccc(N(c2ccc(C)cc2)c2ccc(C=C(c3ccccc3)c3ccccc3)cc2)cc1]

### Comparative Example 5

The photoreceptor was produced in the same manner as in Example 10 except that the compound C4 was changed to the compound represented by the above Structural Formula (C-3).

<Test for Initial Image>

Each of the electrophotographic photoreceptors obtained in Examples and Comparative Examples was mounted in a drum cartridge for A3 monochrome digital copier [KM-1620 (printing speed: A4 horizontal 16 sheets/min, resolution: 600 dpi, exposure source: laser, charging system: scorotron) manufactured by KYOCERA Document Solutions Inc.], and the drum cartridge was set in the above copier.

As a print input, a solid image pattern of halftone was used, so as to print with a copy function, and the resultant output image was visually evaluated. The results were shown in Table 2.

<Evaluation on Electrical Properties of Photoreceptor>

For each of the electrophotographic photoreceptors obtained in Examples and Comparative Examples, the charge potential (potential of the blank) of the photoreceptor was measured separately, using an evaluation device for electrophotographic properties manufactured according to measurement standards of Electrophotography Society of Japan (as described in Foundation and Application of Electrophotographic Technique (Continued), edited by Electrophotography Society of Japan. CORONA PUBLISHING CO., LTD., Pages 404 to 405).

A constant grid voltage was applied, the charge potential after printing one sheet was defined as Vo(1) [V], and the charge potential of printing the 10^{th} sheet was defined as Vo(10) [V]. The results were shown in Table 2.

<Each Parameter Value>

In density function calculation B3LYP/6-31G (d, p), when in the compound having hole transporting ability, the energy level of HOMO of a compound having hole transporting ability with a highest energy level of HOMO (compound A) was set to Ah; in the compound having electron-transporting ability, the energy level of LUMO of a compound having electron-transporting ability with a lowest energy level of LUMO (compound B) was set to Bl; and the energy level of HOMO of a compound (compound C) other than the compound A and the compound B was set to Ch, Ch, Ah-Ch and BI-Ch were determined. The results together with the molecular weights of the compound C were shown in Table 3.

TABLE 2

| | | | Compound having | | Test for initial | Electrical | |
|---|---|---|---|---|---|---|---|
| | Binder | Compound having hole | electron-transporting | | image | properties | |
| | resin | transporting ability | ability | Compound C | Visual evaluation | Vo(1) | Vo(10) |
| Example 1 | PA-1 | C-1 | ET-2 | C-4 | Good | 555 | 689 |
| Example 2 | PA-1 | C-1 | ET-2 | C-4 | Good, slight fog | 502 | 677 |
| Example 3 | PA-1 | C-1 | ET-2 | C-5 | Good | 542 | 688 |
| Example 4 | PA-1 | C-1 | ET-2 | C-5 | Good, slight fog | 512 | 675 |
| Example 5 | PA-1 | C-1 | ET-2 | C-6 | Good | 580 | 691 |
| Example 6 | PA-1 | C-1 | ET-2 | C-6 | Good, slight fog | 521 | 681 |
| Example 7 | PA-1 | C-1 | ET-2 | C-7 | Good | 585 | 699 |
| Example 8 | PA-1 | C-1 | ET-2 | C-8 | Good | 575 | 695 |
| Example 9 | PA-1 | C-1 | ET-2 | C-9 | Good | 585 | 697 |
| Example 10 | PA-1 | C-1 | ET-4 | C-4 | Good, slight fog | 515 | 677 |
| Example 11 | PA-1 | C-2 | ET-2 | C-4 | Good, slightly | 564 | 698 |
| | | | | | low | | |
| Example 12 | PA-1 | C-2 | ET-2 | C-10 | Good, slightly | 564 | 700 |
| | | | | | low | | |
| Example 13 | PA-2 | C-1 | ET-2 | C-4 | Good | 557 | 684 |
| Comparative | PC-1 | C-1 | ET-2 | C-4 | Good | 566 | 698 |
| Example 1 | | | | | | | |
| Comparative | PA-1 | C-1 | ET-2 | C-11 | Fog, unevenness | 481 | 590 |
| Example 2 | | | | | | | |
| Comparative | PA-1 | C-1 | ET-2 | C-12 | Fog, unevenness | 489 | 603 |
| Example 3 | | | | | | | |
| Comparative | PA-1 | C-3 | ET-2 | C-4 | Fog, unevenness | 466 | 582 |
| Example 4 | | | | | | | |
| Comparative | PA-1 | C-1 | ET-4 | C-3 | Fog, unevenness | 352 | 502 |
| Example 5 | | | | | | | |

PA: Polyarylate
PC: Polycarbonate

TABLE 3

| | Compound C | | | Compound A | Compound B |
|---|---|---|---|---|---|
| | Molecular | Ch ≤ −4.69 | Mass percentage based on compound | Ah-Ch ≥ 0.10 | Bl-Ch ≥ 1.18 |
| | weight | eV (1a) | having electron-transporting ability | eV (2a) | eV (3a) |
| Example 1 | 287.4 | −4.72 | 37.5 | 0.15 | 1.39 |
| Example 2 | 287.4 | −4.72 | 12.5 | 0.15 | 1.39 |
| Example 3 | 323.43 | −4.79 | 37.5 | 0.22 | 1.46 |
| Example 4 | 323.43 | −4.79 | 12.5 | 0.22 | 1.46 |
| Example 5 | 220.36 | −5.48 | 37.5 | 0.91 | 2.15 |
| Example 6 | 220.36 | −5.48 | 12.5 | 0.91 | 2.15 |
| Example 7 | 230.31 | −5.98 | 37.5 | 1.41 | 2.65 |
| Example 8 | 234.3 | −5.72 | 37.5 | 1.15 | 2.39 |
| Example 9 | 352.43 | −7.02 | 37.5 | 2.45 | 3.69 |
| Example 10 | 287.4 | −4.72 | 37.5 | 0.15 | 1.21 |
| Example 11 | 287.4 | −4.72 | 37.5 | 0.1 | 1.39 |
| Example 12 | 375.47 | −4.72 | 37.5 | 0.1 | 1.39 |
| Example 13 | 287.4 | −4.72 | 37.5 | 0.15 | 1.39 |
| Comparative | 287.4 | −4.72 | 37.5 | 0.15 | 1.39 |
| Example 1 | | | | | |
| Comparative | 536.67 | −4.69 | 37.5 | 0.12 | 1.36 |
| Example 2 | | | | | |
| Comparative | 530.88 | −5.61 | 37.5 | 1.04 | 2.28 |
| Example 3 | | | | | |
| Comparative | 287.4 | −4.72 | 37.5 | 0.04 | 1.39 |
| Example 4 | | | | | |
| Comparative | 451.6 | −4.68 | 37.5 | 0.11 | 1.17 |
| Example 5 | | | | | |

As seen from Table 2 and Table 3, in Examples 1 to 13, having constitutions satisfying the parameters of the present invention, the surface potential was increased from the first sheet of printing and good images were obtained; in contrast, in Comparative Examples 2 to 5 beyond the ranges of the parameters of the present invention, the charge potential of the first sheet was low, and fog and image unevenness (black band shape) were generated.

In Examples 2, 4 and 6 in which the mass percentage based on the compound having electron-transporting ability was 12.5% and the content of the compound C was relatively small, although slight fog was seen, it was a level that was not problematic in actual use.

In Example 10 in which the difference (Bl−Ch) between the energy level of LUMO of the compound B and the energy level of HOMO of the compound C was relatively small, although it was a level that was not problematic in actual use, slight fog was seen. It was considered that it was because the compound C had a little effect in preventing bleed-out of the compound having electron-transporting ability.

In Examples 11 and 12 in which the difference (Ah-Ch) between the energy level of HOMO of the compound A and the energy level of HOMO of the compound C was relatively small, it was seen that the concentration was slightly lowered. This shows a possibility that the compound C influenced the charge transport.

In Examples 5 to 9, the charging property of the photoreceptor after printing one sheet was better compared with other examples. It was considered that it was because the energy level of HOMO of the compound C used was lower than that of other examples.

<Test for Printing Durable Image>

Next, the photoreceptor obtained in Example 1 and the photoreceptor obtained in Comparative Example 1 were mounted in a drum cartridge for A3 monochrome digital composite machine [TASKalfa 1800 (printing speed: A4 horizontal 18 sheets/min., resolution: 600 dpi, exposure source: laser, charging system: contact roller charging) manufactured by KYOCERA Document Solutions Inc.], and the drum cartridge was set in the above composite machine. In an environment having a temperature of 25° C. and a humidity of 50%, 30,000 images were formed. Table 4 showed the results of image evaluation (wear resistance, cleaning property, and occurrence of filming).

TABLE 4

| | | | | | Test for printing | | |
|---|---|---|---|---|---|---|---|
| | | Compound having | Compound having | | durable image | | |
| | Binder | hole transporting | electron-transporting | | Wear | Cleaning | |
| | resin | ability | ability | Compound C | resistance | property | Filming |
| Example 1 | PA-1 | C-1 | ET-2 | C-4 | Very good | Good | Good |
| Comparative | PC-1 | C-1 | ET-2 | C-4 | Good | Streak | Occur |
| Example | | | | | | defect | |

PA: Polyarylate
PC: Polycarbonate

As seen from Table 4, as compared with Comparative Example 1 using polycarbonate, in Example 1 using polyarylate as the binder resin of the photoreceptor, mechanical properties such as the wear resistance, cleaning property and filming resistance are excellent.

From all the results in Table 2 to Table 4, it is seen that the electrophotographic photoreceptor of the present invention has combined characteristics of excellent in mechanical properties, and of preventing fog at a very initial stage of life duration thereof.

While the present invention has been described in detail and with reference to specific embodiments, it will be apparent to those skilled in the art that various changes and modifications can be made without departing from the spirit and scope of the invention. This application is based on Japanese Patent Application (Patent Application No. 2016-066782) filed on Mar. 29, 2016, the content of which is incorporated herein by reference.

### DESCRIPTION OF REFERENCE NUMERALS

1 Photoreceptor (electrophotographic photoreceptor)
2 Charging device (charging roller; charging unit)
3 Exposure device (exposure unit)
4 Developing device (developing unit)
5 Transfer device
6 Cleaning device
7 Fixing device
41 Developing tank
42 Agitator
43 Supply roller
44 Developing roller
45 Regulating member
71 Upper fixing member (fixing roller)
72 Lower fixing member (fixing roller)
73 Heating device
T Toner
P Recording paper (paper and medium)

1. An electrophotographic photoreceptor for positive charging, the photoreceptor comprising:
a conductive support; and
a single-layer type photosensitive layer disposed on the conductive support, the single-layer type photosensitive layer at least containing a binder resin, a compound having hole transporting ability, and a compound having electron-transporting ability,
wherein the binder resin contains a polyarylate resin, and
when in density function calculation B3LYP/6-31G (d, p),
designating a compound having hole transporting ability with a highest energy level of HOMO in the compound having hole transporting ability as a compound A, and setting the energy level of HOMO of the compound A to Ah,
designating a compound having electron-transporting ability with a lowest energy level of LUMO in the compound having electron-transporting ability as a compound B, and setting the energy level of LUMO of the compound B to Bl, and
designating a compound which has a molecular weight of 500 less and is contained other than the compound A and the compound B in the single-layer type photosensitive layer as a compound C, and setting an energy level of HOMO of the compound C to Ch,
the following Equations (1a), (2a), and (3a) are satisfied:
Ch≤−4.69 (eV) (1a)
Ah−Ch≥0.10 (eV) (2a)
Bl−Ch≥1.18 (eV) (3a).

2. The electrophotographic photoreceptor according to claim 1, wherein the Equation (2a) is
Ah−Ch≥0.11 (eV).

3. The electrophotographic photoreceptor according to claim 1, wherein
when an energy level of LUMO of the compound C is set to Cl, the Ch and the Cl satisfy the following Equations (4a) and (5a):
Ch≤−4.9 (eV) Equation (4a)
Cl≥−3.2 (eV) Equation (5a).

4. The electrophotographic photoreceptor according to claim 1, which comprises the compound C in an amount of 13 mass % or more based on the compound having electron-transporting ability.

5. The electrophotographic photoreceptor according to claim 1, wherein the polyarylate resin has a structural unit represented by the following General Formula (1b): 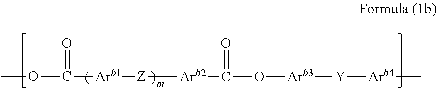
wherein Ar^{b1} to Ar^{b4} each independently represent an arylene group that may have a substituent, Z represents a single bond, an oxygen atom, a sulfur atom, or an alkylene group, m represents an integer of 0 to 2, and Y represents a single bond, an oxygen atom, a sulfur atom, or an alkylene group.

6. An electrophotographic photoreceptor cartridge, comprising:
the electrophotographic photoreceptor for positive charging according to claim 1; and
at least one of a charging unit for charging the electrophotographic photoreceptor, an exposure unit for exposing the charged electrophotographic photoreceptor to light so as to form an electrostatic latent image thereon, a developing unit for developing the electrostatic latent image formed on the electrophotographic photoreceptor, and a cleaning unit for cleaning the electrophotographic photoreceptor.

7. An image forming apparatus, comprising:
the electrophotographic photoreceptor for positive charging according to claim 1;
a charging unit for charging the electrophotographic photoreceptor;
an exposure unit for exposing the charged electrophotographic photoreceptor to light so as to form an electrostatic latent image thereon; and
a developing unit for developing the electrostatic latent image formed on the electrophotographic photoreceptor.
